(19) United States
(12) Patent Application Publication
(10) Pub. No.: US 2026/0086964 A1
(43) Pub. Date: Mar. 26, 2026

(54) DRAM with Single Clock for Command/Address and Write Data

(71) Applicant: Apple Inc., Cupertino, CA (US)

(72) Inventors: Rajesh K. Mahajan, San Jose, CA (US); Gihong Kim, San Jose, CA (US); Seong Min Seo, Campbell, CA (US); Subhasis Mukherjee, Milpitas, CA (US); Farid Nemati, Los Altos Hills, CA (US)

(21) Appl. No.: 19/333,933

(22) Filed: Sep. 19, 2025

Related U.S. Application Data
(60) Provisional application No. 63/697,989, filed on Sep. 23, 2024.

(51) Int. Cl. G06F 13/20

(52) U.S. Cl. CPC G06F 13/20; G06F 2213/16

(57) ABSTRACT

A dynamic random-access memory (DRAM) device includes a set of DRAM cells and an external interface, which includes a pair of clock interface pins, four pins for a command and address bus, and 32 pins for a data bus. The command and address bus is configured to convey memory commands and addresses to the set of DRAM cells, while the data bus is configured to convey memory access data to and from the set of DRAM cells. The DRAM device includes a clock distribution circuit coupled to the pair of pins, and is configured to receive at the pair of pins, a differential clock signal, and drive, by the clock distribution circuit based on the first differential clock signal, an indication of validity of information on the command and address bus, as well as an entirety of write data on the data bus.

The present application claims priority to U.S. Provisional App. No. 63/697,989, entitled “Low Power Double Data Rate Wide Input/Output,” filed Sep. 23, 2024, the disclosure of which is incorporated by reference herein in its entirety.

### BACKGROUND

### Technical Field

The present application relates generally to dynamic random-access memory (DRAM), and more particularly to techniques relating to a low-power version of DRAM.

### Description of the Related Art

Low-Power Double Data Rate (LPDDR) DRAM is a type of DRAM that consumes less power than other forms of DRAM. LPDDR targets mobile computers and devices. Various LPDDR standards exist. One version of LPDDR5, a recent standard, has a transfer rate of 6,400 megabits per second (Mbps), equivalent to 6,400 mega transfers per second (MT/s), and is considered twenty percent more efficient than prior LPRDDR generations.

### BRIEF DESCRIPTION OF THE DRAWINGS

FIG. 1 is a block diagram of one embodiment of a computer system with an external DRAM memory system with a low-power, wide-IO (LPW) interface.

FIG. 2 is a block diagram of some elements of one embodiment of a computer system.

FIG. 3 illustrates aspects of an external memory system in one embodiment of a computer system.

FIG. 4 is a block diagram of one embodiment of an LPW DRAM device.

FIG. 5A is a block diagram illustrating one embodiment of a pinout diagram for one embodiment of an LPW DRAM device.

FIG. 5B is a block diagram illustrating one embodiment of circuitry used to distribute a clock signal to indicate validity of write data in an LPW DRAM.

FIG. 5C is a flow diagram of one embodiment of a method for indicating validity of information received at the interface of an LPW DRAM device.

FIGS. 6A, 6B, and 6C illustrate exemplary values for various timing parameters in a LPW memory, according to some embodiments.

FIG. 7A illustrates an example of a timing diagram for activate commands, according to some embodiments.

FIG. 7B is a block diagram of one embodiment of a DRAM device and its power distribution circuit.

FIGS. 7C-D are block diagrams of a memory controller circuit configured to implement a two-activate timing window for DRAM.

FIGS. 7E-F are flow diagrams of embodiments of methods for implementing a two-activate timing window for DRAM.

FIG. 8 illustrates an example of a timing diagram for an activate, read, and precharge command.

FIG. 9 illustrates an example of a timing diagram for a burst read timing with precharge and activate commands, according to some embodiments.

FIG. 10 illustrates an example of a timing diagram for a BG mode BL 16 read, according to some embodiments.

FIG. 11 illustrates an example of a timing diagram for a BG mode interleaved BL 16 read, according to some embodiments.

FIG. 12 illustrates an example of a timing diagram for a non-BG mode BL 16 read, according to some embodiments.

FIG. 13 illustrates an example of a timing diagram for a BL 8 read with refresh command, according to some embodiments.

FIG. 14 illustrates an example of a timing diagram for burst write timing, according to some embodiments.

FIG. 15 illustrates an example of a timing diagram for a BG mode BL 16 write, according to some embodiments.

FIG. 16 illustrates an example of a timing diagram for a BG mode interleaved BL 16 write, according to some embodiments.

FIG. 17 illustrates an example of a timing diagram for an activate command followed by a write command, according to some embodiments.

FIG. 18 illustrates an example of a timing diagram for a read command followed by a write command, according to some embodiments.

FIG. 19 illustrates an example of a timing diagram for a write command followed by a read command, according to some embodiments.

FIG. 20 illustrates an example of a memory die stack, according to some embodiments.

FIG. 21 is a diagram illustrating example applications for systems and devices employing the disclosed techniques.

FIG. 22 is a block diagram illustrating an example computer-readable medium that stores circuit design information for implementing devices that employ the disclosed techniques.

### DETAILED DESCRIPTION

This disclosure is directed to a DRAM that is particularly well suited for power-constrained systems. This memory is low power with a relatively wide input/output (I/O or IO) interface. This memory is referred to as LPW memory, and the interface to this memory as an LPW interface.

As computer device bandwidth demands continue to increase (such as by the emergence of memory-and-processor-intensive artificial intelligence (AI) applications), LRDDR6 has addressed this demand by progressing to higher bit rates, which has in turn led to increased total access energy per bit. This combination has led to much higher total power demands. Such a trajectory is likely not sustainable for many power-constrained devices.

To address these needs, embodiments described herein are directed to aspects of the LPW memory referred to above. Embodiments described herein can provide a 2× reduction in total energy per bit as compared to LPDDR6, compatibility with conventional wire-bond DRAM packaging and testing, provide a die overhead comparable to LPDDR, and provide a similar-or-better bandwidth as compared to LPDDR6 per DRAM package. Various DRAM commands described herein optimize command/address (CA) bandwidth as well as timing parameters. In some instances, embodiments can be packaged more compactly as compared to current LPDDR6 packaging. Further, the wider and slower interface of LPW (“wide IO”) relative to IOs of prior LPDDR standards can enable energy-efficient unterminated IOs, lower operating voltages, and more efficient clocking. Further, in some instances, LPW, for a given DRAM package, can achieve a similar or better bandwidth as compared to LPDDR6.

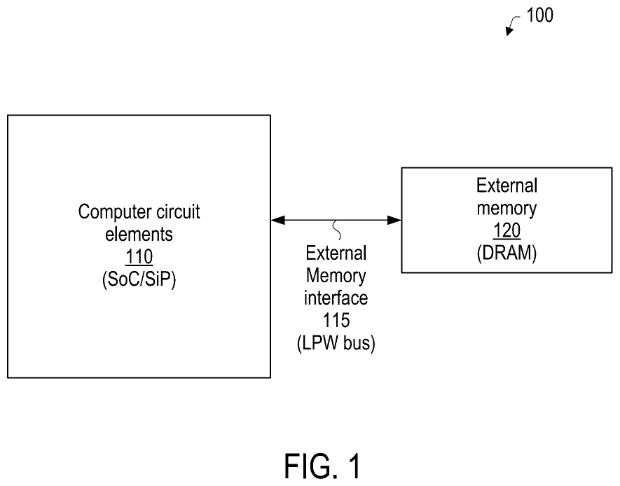

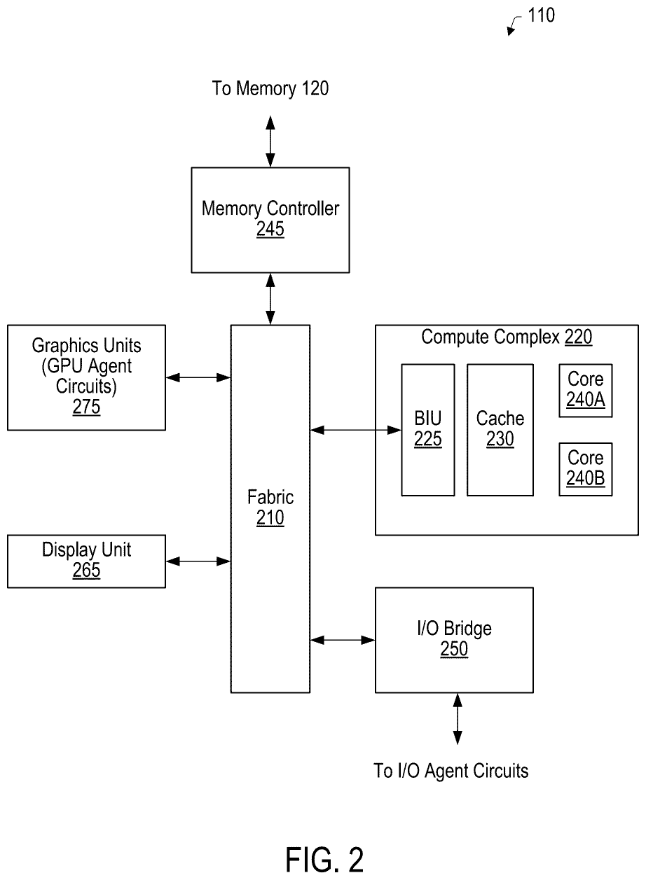

Turning to FIG. 1, a block diagram of a computer system with an LPW memory is illustrated. As depicted, computer system 100 includes computer circuit elements 110 that are formed on one or more co-packaged integrated circuits (ICs). If elements 110 are formed on a single IC, such an arrangement may be referred to as a system on a chip (SoC); conversely, if elements 110 are formed on multiple ICs, such an arrangement may be referred to as a system in a package (SiP), or chiplet architecture. One possible embodiment of computer circuit elements 110 is described below with respect to FIG. 2.

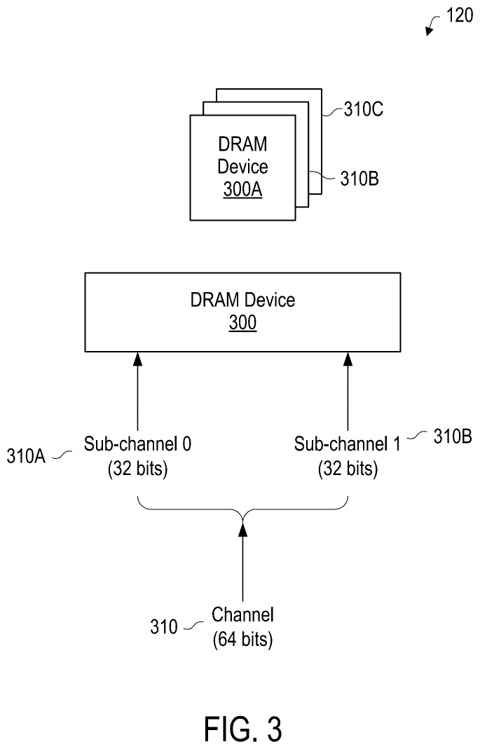

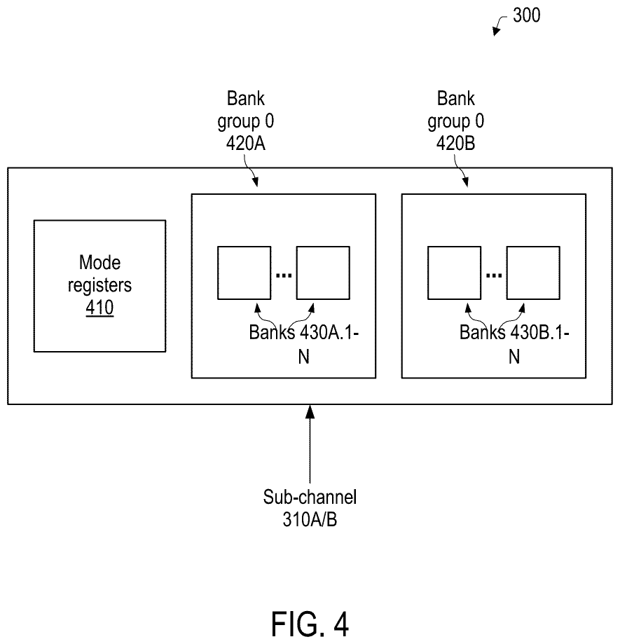

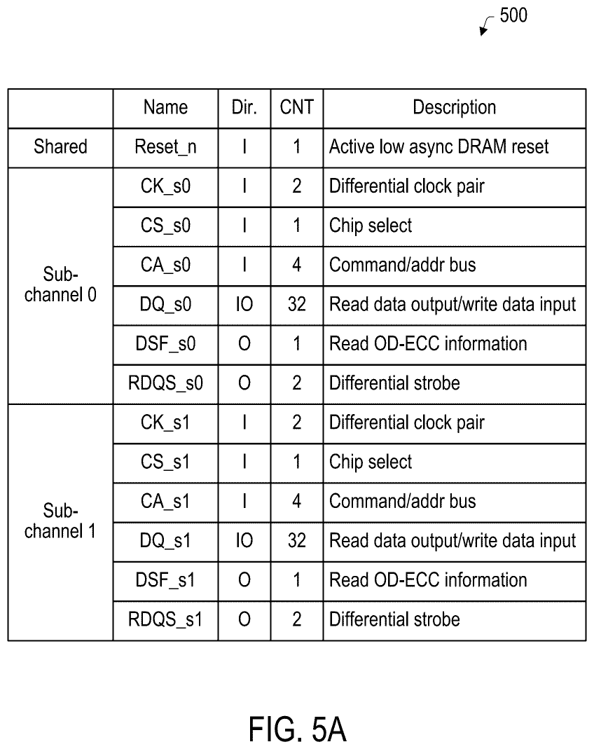

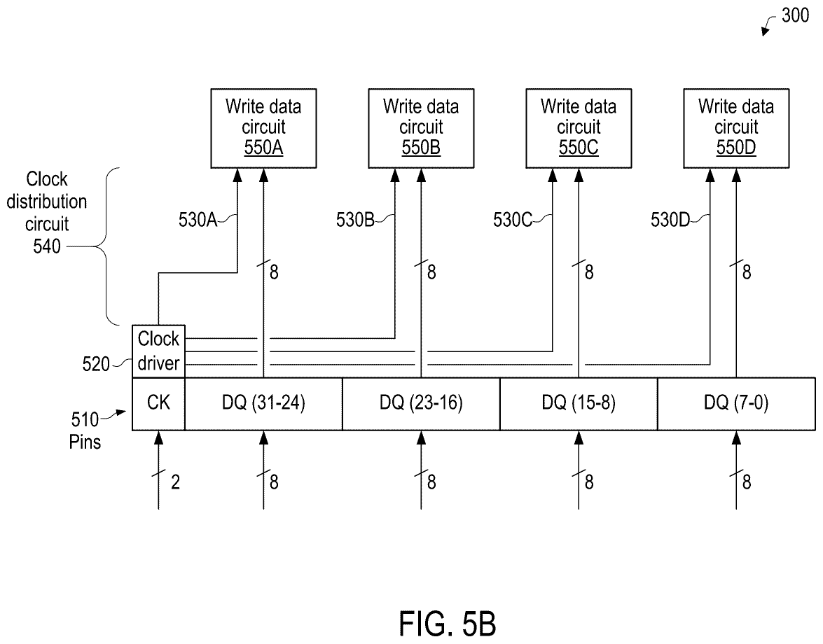

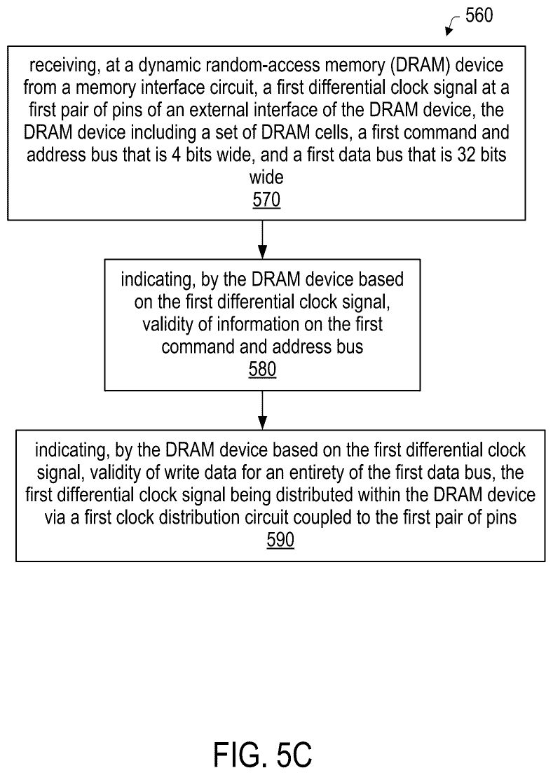

Coupled to elements 110 via external memory interface 115 is external system memory 120. External system memory 120 is “external” in that it is outside and coupled to the packaging of elements 110. The DRAM of external system memory 120 makes up the main memory of computer system 100. Details of embodiments of external system memory 120 are described below with respect to FIGS. 3A, 3B, and 4. A detailed description of a pinout of a DRAM device within external system memory 120 is described below with reference to FIG. 5.

Referring now to FIG. 2, a block diagram illustrating an example embodiment of a portion of computer system 100, computer circuit elements 110, is shown. In some embodiments, elements 110 may be included in a mobile device, which may be battery powered. Therefore, power consumption by elements 110 may be an important design consideration. In the illustrated embodiment, elements 110 include fabric 210, compute complex 220 input/output (I/O) bridge 250, memory controller 245, graphics unit 275, and display unit 265. In some embodiments, elements 110 may include other components (not shown) in addition to or in place of the illustrated components, such as video processor encoders and decoders, image processing or recognition elements, computer vision elements, etc.

Fabric 210, which may also be referred to as a “network circuit,” may include various interconnects, buses, multiplexers, controllers, etc., and may be configured to facilitate communication between various elements 110. In some embodiments, portions of fabric 210 may be configured to implement different communication protocols. In other embodiments, fabric 210 may implement a single communication protocol and elements coupled to fabric 210 may convert from the single communication protocol to other communication protocols internally.

In the illustrated embodiment, compute complex 220 includes bus interface unit (BIU) 225, cache 230, and cores 240A-B, which may also be referred to as processor circuits. In various embodiments, compute complex 220 may include various numbers of processors, processor cores and caches. For example, compute complex 220 may include 1, 2, or 4 processor cores, or any other suitable number. In one embodiment, cache 230 is a set associative L2 cache. In some embodiments, cores 240A-B may include internal instruction and data caches. In some embodiments, a coherency unit (not shown) in fabric 210, cache 230, or elsewhere in elements 110 may be configured to maintain coherency between various caches of elements 110. BIU 225 may be configured to manage communication between compute complex 220 and other elements 110. Processor cores such as cores 240A-B may be configured to execute instructions of a particular instruction set architecture (ISA) which may include operating system instructions and user application instructions. These instructions may be stored in computer readable medium such as a memory coupled to memory controller circuit 245 discussed below.

As used herein, the term “coupled to” may indicate one or more connections between elements, and a coupling may include intervening elements. For example, in FIG. 2, graphics unit 275 may be described as “coupled to” memory through fabric 210 and memory controller 245. In contrast, in the illustrated embodiment of FIG. 2, graphics unit 275 is “directly coupled” to fabric 210 because there are no intervening elements.

Memory controller circuit 245 may be configured to manage transfer of data between fabric 210 and one or more caches and memories. In various embodiments, memory controller circuit 245 may be coupled to an L3 cache, which may in turn be coupled to system memory indicated by external memory 120 via a memory interface circuit (not pictured).

Graphics unit 275 may include one or more processors commonly referred to graphics processing units, or GPUs. Graphics unit 275 may receive graphics-oriented instructions, such as OPENGL®, Metal®, or DIRECT3D® instructions, for example. Graphics unit 275 may execute specialized GPU instructions or perform other operations based on the received graphics-oriented instructions. Graphics unit 275 may generally be configured to process large blocks of data in parallel and may build images in a frame buffer for output to a display, which may be included in the device or may be a separate device. Graphics unit 275 may include transform, lighting, triangle, and rendering engines in one or more graphics processing pipelines. Graphics unit 275 may output pixel information for display images. Graphics unit 275, in various embodiments, may include programmable shader circuitry which may include highly parallel execution cores configured to execute graphics programs, which may include pixel tasks, vertex tasks, and compute tasks (which may or may not be graphics-related).

Display unit 265 may be configured to read data from a frame buffer and provide a stream of pixel values for display. Display unit 265 may be configured as a display pipeline in some embodiments. Additionally, display unit 265 may be configured to blend multiple frames to produce an output frame. Further, display unit 265 may include one or more interfaces (e.g., MIPI® or embedded display port (eDP)) for coupling to a user display (e.g., a touchscreen or an external display).

I/O bridge 250 may include various elements configured to implement: universal serial bus (USB) communications, security, audio, and low-power always-on functionality, for example. I/O bridge 250 may also include interfaces such as pulse-width modulation (PWM), general-purpose input/output (GPIO), serial peripheral interface (SPI), and inter-integrated circuit (I2C), for example. Various types of peripherals and devices may be coupled to elements 110 via I/O bridge 250.

In some embodiments, elements 110 include network interface circuitry (not explicitly shown), which may be connected to fabric 210 or I/O bridge 250. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide elements 110 with connectivity to various types of other devices and networks.

As has been described previously, various elements 110 may exist in different power domains. For example, one domain may include the various components coupled to fabric 210, as well as a portion of memory controller 245. Another domain may include a portion of memory controller 245 that interfaces to external memory 120.

Various circuits depicted in FIG. 2 are agent circuits, which means that they are circuits that implement functionality for agents within computer system 100. As used herein, an agent is any component or device (e.g., processor, peripheral, memory controller, etc.) that sources and/or sinks communications on fabric 210. A source agent circuit generates (sources) a communication, and a destination agent circuit receives (sinks) the communication. A given agent circuit may be a source agent for some communications and a destination agent for other communications.

As used herein, a “processor circuit” refers to any type of central processing unit (CPU). A given processor circuit (e.g., 240A-B) can include multiple cores. For example, one implementation might include a single component with one processing element (i.e., one processor core). Another implementation might include a single component with multiple processor cores. Yet another implementation might include a processor cluster with multiple components, each of which may include multiple processor cores.

“Memory controllers,” on the other hand refer to any circuit (e.g., memory controller circuit 245) that interfaces to system memory, which includes DRAM. Some embodiments of memory controllers may include memory caches, while others may not.

Fabric 210 may be representative of different fabrics connecting different agent circuits within elements 110 to memory 120. For example, one fabric may connect processor circuits to memory controller circuit 245, while another fabric may connect SoC agents or I/O agents to memory controller circuit 245. Example of I/O agent circuits include an internal or external display (e.g., display 265), one or more cameras (including associated image signal processor circuits), a Smart IO circuit, and interfaces to various buses such as USB and PCIe. I/O agents may be seen as a subset of SoC agents, a category that may include a secure enclave processor, a neural processing engine, JPEG codec circuits, video encoding/decoding circuits, a power manager circuit, an always-on (AON) circuit, etc. Still another fabric may connect graphics processing units (GPU agents 275) to memory.

A given network circuit, or fabric, is composed of various elements, such as network switches and various wires, buses, interconnects, etc., which can collectively be referred to as the “fabric” of that network. A given network can be arranged according to any suitable network topology, including ring, mesh, star, tree, etc. Each network may employ a topology that provides the bandwidth and latency attributes desired for that network, for example, or provides any desired attribute for the network. Thus, computer system 100 may include at least a first network constructed according to a first topology and a second network constructed according to a second topology that is different from the first topology. Note that the first and second network may be packet-switched networks in some embodiments. In some cases, each network may have different operational parameters—for example, different types of network transactions (e.g., different types of snoops), different types of properties for transactions, different transaction ordering properties, etc.

Generally speaking, the ordering properties of a given network specify which communications on the network are required to remain in order. Communications for which a particular order is not required may be reordered on the network (e.g., a younger communication may complete before an older communication). For example, a “relaxed”-order network used with GPUs may have reduced ordering constraints compared to CPU and I/O networks. In an embodiment, a set of virtual channels and subchannels within the virtual channels are defined for each network. For the CPU and I/O networks, communications that are between the same source and destination agent, and in the same virtual channel and subchannel, may be ordered. For the relaxed-order network, communications between the same source and destination agent may be ordered if they are to the same address (at a given granularity, such as a cache block). Otherwise, the communications need not be ordered. Because less strict ordering is enforced on the relaxed-order network, higher bandwidth may be achieved on average since transactions may be permitted to complete out of order if younger transactions are ready to complete before older transactions, for example. Other ordering constraints may be implemented in other embodiments. For example, the ordering requirements defined for a peripheral component interconnect (PCI) and its various versions such as PCIe may be implemented.

Given the different functionalities of possible networks within computer system 100, these networks can operate independently from one another. Networks may be physically independent (e.g., having dedicated wires and other circuitry that form the network) and logically independent (e.g., communications sourced by agent circuits in computer system 100 may be logically defined to be transmitted on a selected network of the plurality of networks and thus not impacted by transmission on other networks). In some embodiments, network switches may be included to transmit packets on a given network. The network switches may be physically part of the network (e.g., there may be dedicated network switches for each network). In other embodiments, a network switch may be shared between physically independent networks and thus may ensure that a communication received on one of the networks remains on that network.

By providing physically and logically independent heterogenous networks, high bandwidth may be achieved via parallel communication on different networks. Additionally, different traffic may be transmitted on different networks, and thus a given network may be optimized for a particular type of traffic. For example, processor circuits 240A-B may be sensitive to memory latency and may cache data that is expected to be coherent among the processors and memory 120. Accordingly, a particular network to which processor circuits 240A-B are coupled may be optimized to provide the required low latency for transactions between these components. There may be separate virtual channels for low latency requests and bulk requests, in various embodiments. The low latency requests may be favored over the bulk requests in forwarding around the network and by the memory controllers. The CPU network may also support cache coherency with messages and protocols defined to communicate coherently.

As used herein, “virtual channels” are channels that physically share a network but which are logically independent of each other on the network. Accordingly, communications in one virtual channel between network elements do not block progress of communications on another virtual channel between the network elements. A particular virtual channel may be implemented by used routing storage dedicated to that channel. A given virtual channel may have one or more sub-channels.

Given the foregoing description, it is apparent that computer system 100 may include various networks that are heterogeneous, with different topologies, communication protocols, semantics, ordering properties, etc. Such networks may implement different cache coherency protocols, for example. In embodiments that include a GPU network, such a network and other networks of computer system 100 may each include different ordering properties (e.g., different cache coherency properties such as strict or relaxed ordering), given the different function and design specifications of each network.

FIG. 3 illustrates aspects of one embodiment of an external memory system of a computer system. As depicted, external memory system 120 includes multiple DRAM devices 300A. A given DRAM device, an embodiment of which is depicted in more detail with respect to FIG. 4, includes a set of DRAM cells that are configured to store information while power is maintained to these devices. Note that various ones of DRAM devices 300 (e.g., DRAM device 300A and 300B, may be stacked within a common package in some embodiments).

Also depicted in FIG. 3 is a representation of an interface to a given DRAM device 300. Interface 310 is designated as a single channel that is 64 bits in width. This single channel is composed of two sub-channels: sub-channel 0 (indicated by reference numeral 310A), and sub-channel 1 (indicated by reference numeral 310B). As will be described next, different portions of DRAM cells within DRAM device 300 correspond to different sub-channels.

FIG. 4 is an internal block diagram of one embodiment of a portion of a DRAM device that corresponds to a sub-channel within interface 115. As depicted, this portion of DRAM device 300 includes mode registers 410, and DRAM cells arranged within bank group 420A and bank group 420B. A DRAM bank group (BG) is a hierarchical organizational unit within a DRAM chip introduced in DDR4 to increase I/O bandwidth and internal parallelism. A bank group consists of several DRAM banks (e.g., banks 430A.1-N in bank group 0 and banks 430B.1-N in bank group 1) that share some resources but can operate independently to a degree. With the hierarchy of a DRAM, bank groups sit above individual banks and below channels. The banks within a bank group can have some shared resources (e.g., mode registers 410 in some embodiments).

By grouping banks, memory controllers can exploit bank-group level parallelism and improve performance by providing more access paths than older architectures with only bank-level parallelism. Bank groups thus increase I/O bandwidth without having to increase the width of the internal DRAM bus. Banks within different bank groups can be accessed faster than banks within the same bank group, as there are fewer timing restrictions and more parallel access paths available. In some embodiments, a memory controller circuit may use XOR-based hash functions to map physical addresses to DRAM components, including the bank group. Where there are four bank groups, for example, two bank select bits, BG0 and BG1, are used for bank group selection. A bank 430, in turn, is organized into rows and columns, with a row buffer (not pictured) holding a current row for fast access.

FIG. 5A illustrates a table 500 that lists pinouts for one embodiment of DRAM device 300. Note that the pinout necessarily indicates which signals are part of the bus of computer system 100 that makes up interface 115. Table 500 shows that a reset signal is shared by both sub-channels 0 and 1. The interface for each of the sub-channels is otherwise identical. A given sub-channel receives a chip select signal, as well as differential clock pair, which is used to clock a 4-bit command and address (CA) bus and write data being sent to DRAM device 300 via 32-bit data bus DQ. The CA bus and the data bus thus both run on the same clock signal. A differential strobe (RDQS) is used to clock read data on data bus DQ.

FIG. 5B is a block diagram of one embodiment of a portion of DRAM device that is configured to indicate validity of write data being conveyed to the set of DRAM cells. Depicted in FIG. 5B is a portion of pins 510 of external interface 115 of DRAM device 300. These pins include a pair of pins (CK) coupled to receive a differential clock signal, as well as 32 pins that are coupled to receive 32 bits (4 bytes) of write data. The bus interface circuitry shown in FIG. 5B operates at the granularity of bytes of data. Write data received at the data pins is conveyed to a set of internal write data circuits 550A-D, each of which is configured to handle a corresponding byte of write data for further processing.

For LPW memory, in order to save pin count and power, validity is indicated for an entirety of the 32-bit first data bus by a single differential clock pair received at interface 115 (i.e., for a first sub-channel). As noted in FIG. 5A, a separate differential clock pair is received for a second sub-channel having a second, 32-bit data bus. In contrast to using multiple clocks for a 32-bit DRAM data bus, DRAM device 300 uses only a single clock pair.

This single clock pair is distributed within DRAM device 300 by a clock distribution circuit 540, which in one embodiment, includes a clock driver 520 and a clock distribution network 530 that includes various elements, including traces 530A-D. Clock distribution circuit 540 is designed such that the differential clock signal can be driven to destinations within DRAM device (e.g., each of write data circuits 550A-D) at a sufficient level to indicate validity of an entirety of the 32-bit data bus. Each portion of clock distribution network is designed with this end in mind, ensuring that the load-driving capacity of clock distribution 540 is adequate. For example, clock driver 520 illustrated in FIG. 5B may be a single initial gate that is coupled to the pair of clock pins at the interface and is designed such that it has a sufficient fan-out to drive the clock signal throughout clock distribution network 530. Alternatively, clock driver 520 may include two buffers, with the load for driving the clock signal within clock distribution network 530 split between these buffers. Note that clock distribution circuit 540 may include multiple levels of buffers in various embodiments. In this manner, DRAM device 300 is designed with additional circuitry to allow 32 bits of write data to be clocked by a single differential clock pair.

Turning now to FIG. 5C, a flow diagram of one embodiment of a method 560 for indicating validity of write data is shown. Method 560 is performed by a DRAM device, which includes a set of DRAM cells, a first command and address bus that is 4 bits wide, and a first data bus that is 32 bits wide. Method 560 begins at 570, with the DRAM device receiving, from a memory interface circuit, a first differential clock signal at a first pair of pins of an external interface of the DRAM device. Method 560 then continues at 580, with the DRAM device indicating, based on the first differential clock signal, validity of information on the first command and address bus. Method 560 then concludes at 590, with the DRAM device indicating, based on the first differential clock signal, validity of write data for an entirety of the first data bus. The first differential clock signal is distributed within the DRAM device via a first clock distribution circuit coupled to the first pair of pins.

Various embodiments of method 560 are contemplated. For example, method 560 may further include the DRAM device receiving, from the memory interface circuit, a differential read strobe signal at a different pair of pins of the external interface of the DRAM device; and indicating, based on the differential read strobe signal, validity of read data on the first data bus that has been accessed from the set of DRAM cells.

As has been noted, the set of DRAM cells may include a plurality of different portions, including a first portion of DRAM cells addressable via a first sub-channel that includes the first command and address bus and the first data bus, and a second portion of DRAM cells addressable via a second sub-channel that includes a second command and address bus and a second data bus. In some implementations, the set of DRAM cells includes, in addition to the first portion and the second portion, one or more additional portions, wherein each of the plurality of portions has a 32-bit data bus interface to the set of DRAM cells.

The additional sub-channels may operate in the same manner as the first sub-channel that includes the first data bus. For example, method 560 may include the DRAM device receiving, from the memory interface circuit, a second differential clock signal at a second pair of pins of the external interface of the DRAM device; indicating, based on the second differential clock signal, validity of information on the second command and address bus; and indicating, based on the second differential clock signal, validity of data on an entirety of the second data bus, the second differential clock signal being distributed within the DRAM device via a second clock distribution circuit coupled to the second pair of pins.

As has been discussed, external memory 120 may operate at a number of different transfer rates: 3200 mega transfers per second (MT/s), 1600 MT/s, 800 MT/s. In one embodiment, the first data bus may thus be described as operating at a transfer rate of over 3000 MT/s. This disclosure is also intended to cover embodiments in which external memory 120 operates at over 3200 MT/s.

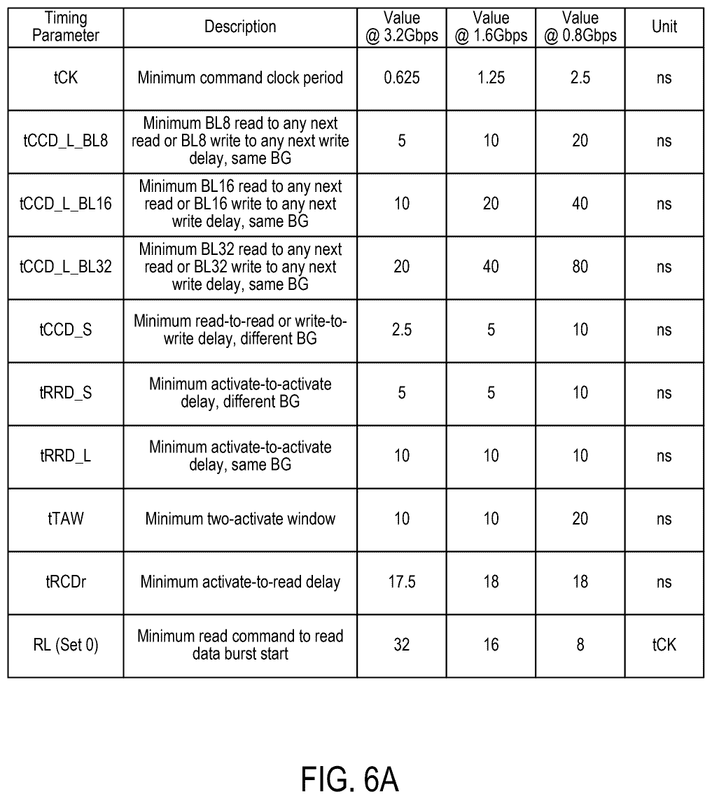

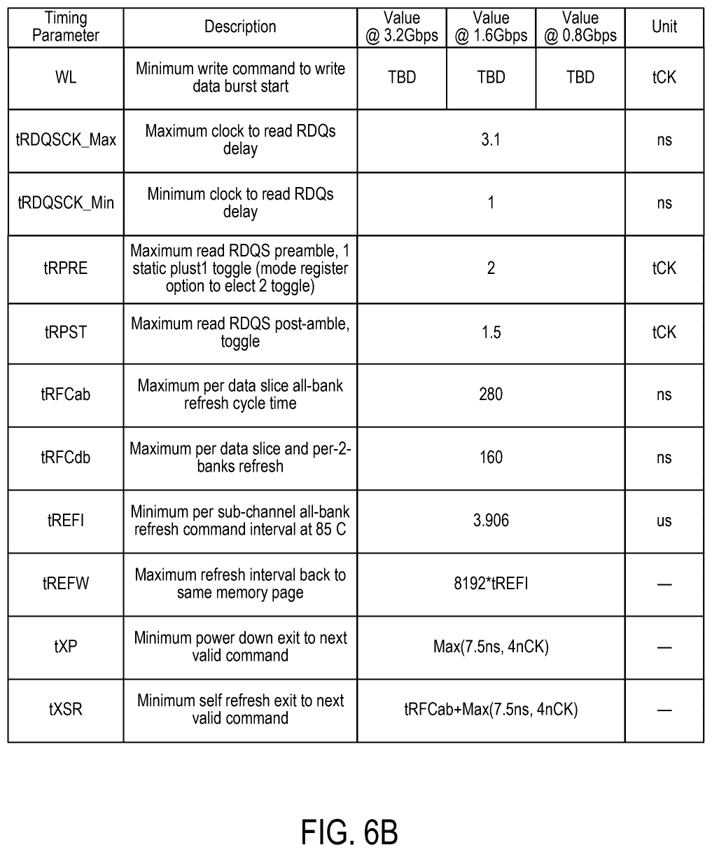

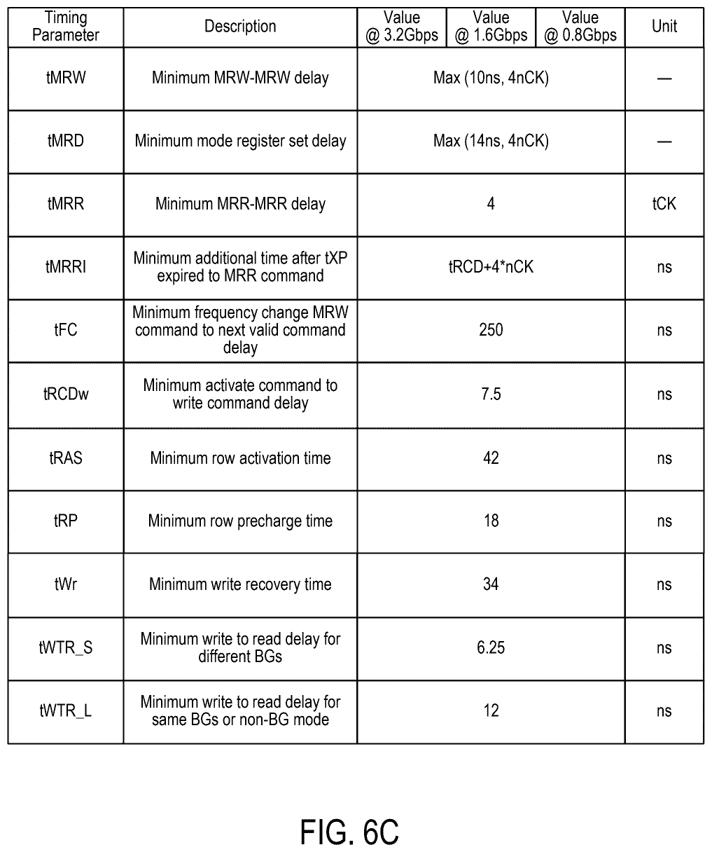

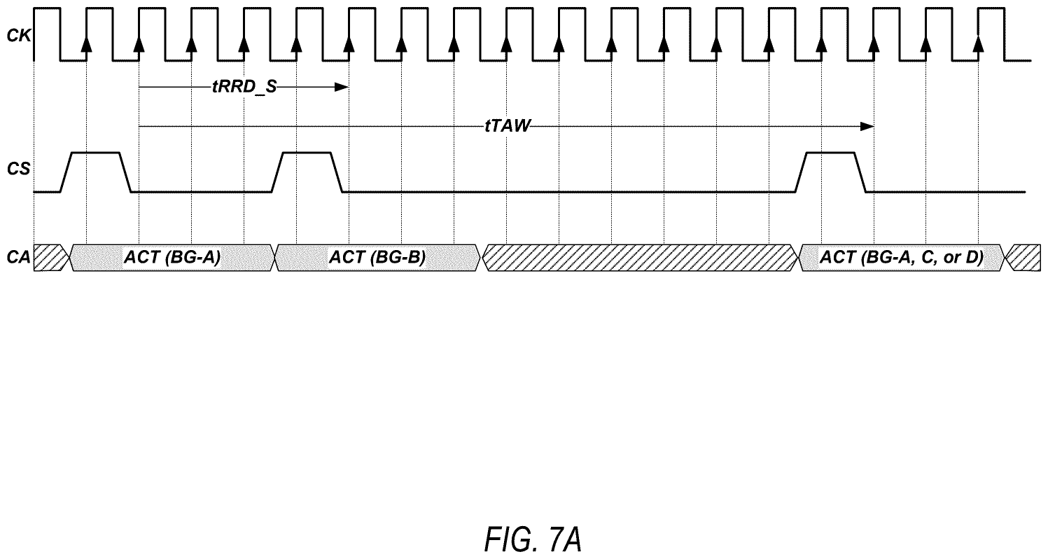

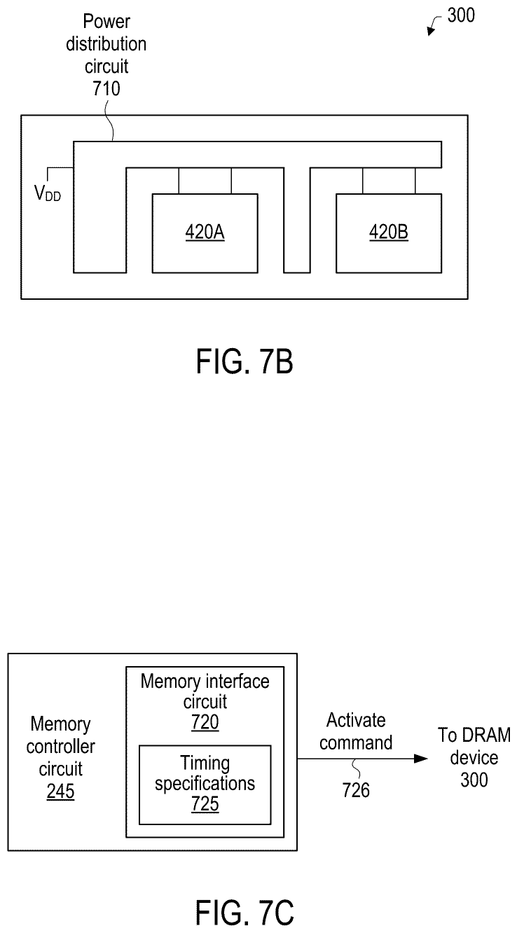

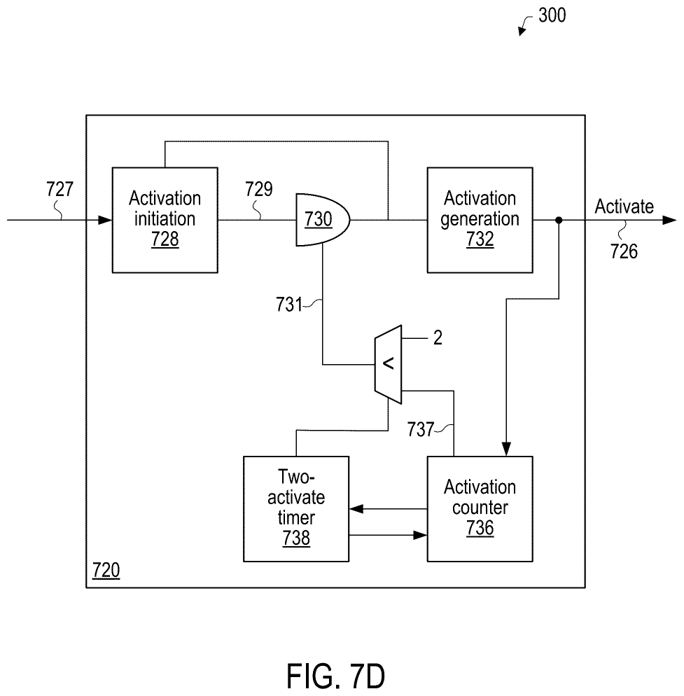

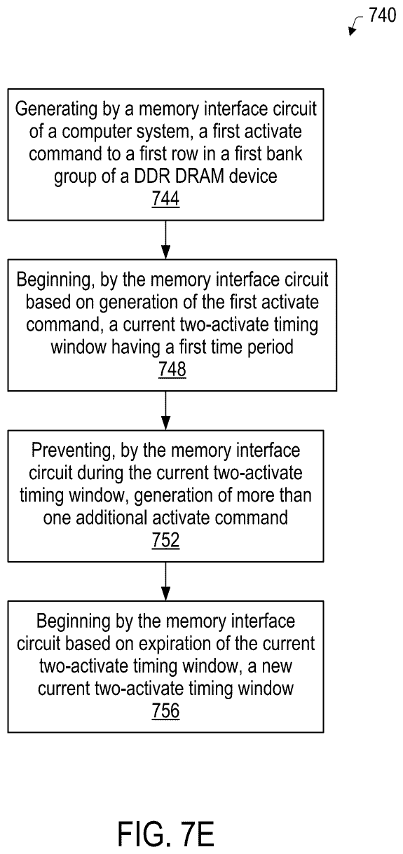

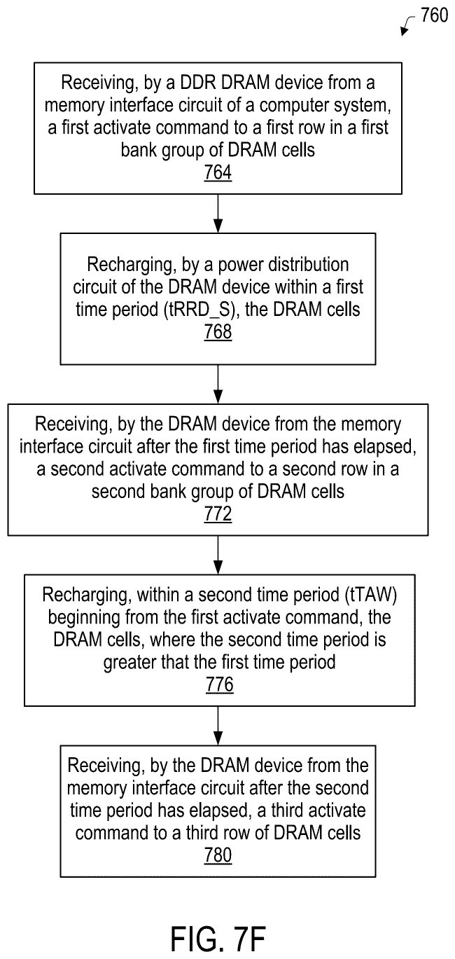

FIGS. 6A, 6B, and 6C illustrate exemplary values for various timing parameters in LPW, according to some embodiments. In addition, FIGS. 7 through 19 illustrate various timing relationships between various commands in LPW, according to some embodiments.

For example, as illustrated by FIGS. 6A, 6B, and 6C, a minimum command clock period (e.g., tCK) can be based on memory access speed, e.g., 3.2 gigabits per second (Gbps, or 3200 MT/s)), which corresponds to a command clock period of 0.625 nanoseconds (ns). At at a memory access speed of 1.6 Gbps (1600 MT/s), the clock period is 1.25 ns. In addition, other parameters can be based on a memory access speed and burst length. For example, for a memory bank group, a minimum delay from a read to any next read or a write to any next write in the same bank group (e.g., tCCD_L_BL8, tCCD_L_BL16, and/or tCCD_L_BL32) can be dependent on burst length (e.g., a number of data transfers per burst) and memory access speed. As shown, for a burst length 8 (BL8), the minimum delay (e.g., tCCD_L_BL8) can be specified as 5 ns for a memory access speed of 3.2 Gbps, 10 ns for a memory access speed of 1.6 Gbps, and 20 ns for a memory access speed of 0.8 Gbps (800 MT/s). Further, for a burst length 16 (BL16), the minimum delay (e.g., tCCD_L_BL16) can be specified as 10 ns for a memory access speed of 3.2 Gbps, 20 ns for a memory access speed of 1.6 Gbps, and 40 ns for a memory access speed of 0.8 Gbps, and for a burst length 32 (BL32), the minimum delay (e.g., tCCD_L_BL32) can be specified as 20 ns for a memory access speed of 3.2 Gbps, 40 ns for a memory access speed of 1.6 Gbps, and 80 ns for a memory access speed of 0.8 Gbps. As another example, a minimum delay from a read to any next read or a write to any next write (e.g., tCCD_S) from a first memory bank group to a second memory bank group that is different than the first memory bank group can be specified as 2.5 ns for a memory access speed of 3.2 Gbps, 5 ns for a memory access speed of 1.6 Gbps, and 10 ns for a memory access speed of 0.8 Gbps. As a further example, a minimum delay between activate commands (e.g., tRRD_S) from a first memory bank group to a second memory bank group that is different than the first memory bank group can be specified as 5 ns for a memory access speed of 3.2 Gbps, 5 ns for a memory access speed of 1.6 Gbps, and 10 ns for a memory access speed of 0.8 Gbps. In contrast, a minimum delay between activate commands (e.g., tRRD_L) for the same memory bank group is 10 ns for any memory access speed. These and other parameters can be further illustrated via the description of FIGS. 7 through 19.

A command truth table for one set of commands that may be issued over an LPW channel (e.g., for each LPW channel) can be defined as shown below in Table 1. Commands included in Table 1 are as follows:
DESELECT: the DRAM takes no action based on that command;
NOP: no operation;
PDE: puts a sub-channel in a low-power state;
SRE: puts a sub-channel in self-refresh;
SRX: takes DRAM out of self-refresh mode;
ACT: activates a row;
READ (RD): reads a burst from the given column address of the currently open page in the bank addressed;
WRITE (WR): writes a burst to the given column address of the currently open page in the bank addressed;
MRR: reads data from mode registers and returns that data on the data bus;
MPC: used to perform various multi-purpose commands;
MRW: writes data from the command/address bus to mode registers;
PRE: precharges the open row in the specified bank;
REF: periodically refresh the DRAM array;
WFF: writes data into the training FIFO;
RFF: reads data from the training FIFO; and
RDC: performs read data calibration procedure by reading data from specified mode registers.

Note that an LPW command may take one, two, or four clock cycles. Note further that CA pins are DDR and can be specified at both a rising edge and a falling edge of a DRAM clock (tCK) transition (e.g., at a rising edge and a falling edge of each tCK transition).

TABLE 1
LPW Command Truth Table

| COMMAND | tCK | CS | CA[0] | CA[1] | CA[2] | CA[3] |
|---|---|---|---|---|---|---|
| DESELECT | R1 | L | X | X | X | X |
| | F1 | X | X | X | X | X |
| NOP | R1 | H | L | L | L | V |
| | F1 | X | L | L | L | V |
| | R2 | H | V | V | V | V |
| | F2 | X | V | V | V | V |
| PDE | R1 | H | L | L | L | V |
| | F1 | X | L | H | L | V |
| | R2 | H | V | V | V | V |
| | F2 | X | V | V | V | V |
| SRE | R1 | H | L | L | L | V |
| | F1 | X | L | L | H | PD |
| | R2 | H | V | V | V | V |
| | F2 | X | V | V | V | V |
| SRX | R1 | H | L | L | L | V |
| | F1 | X | L | H | H | V |
| | R2 | H | V | V | V | V |
| | F2 | X | V | V | V | V |
| ACT-1 | R1 | H | H | H | H | V |
| | F1 | X | H | R15 | R16 | SC |
| | R2 | H | R11 | R12 | R13 | R14 |
| | F2 | X | BA0 | BA1 | BG0 | BG1 |
| ACT-2 | R1 | H | H | H | H | V |
| | F1 | X | L | R8 | R9 | R10 |
| | R2 | H | R4 | R5 | R6 | R7 |
| | F2 | X | R0 | R1 | R2 | R3 |
| READ | R1 | H | BL0 | H | L | BL1 |
| | F1 | X | C0 | C1 | AP | SC |
| | R2 | H | C2 | C3 | C4 | C5 |
| | F2 | X | BA0 | BA1 | BG0 | BG1 |
| WRITE | R1 | H | BL0 | L | H | BL1 |
| | F1 | X | C0 | C1 | AP | SC |
| | R2 | H | C2 | C3 | C4 | C5 |
| | F2 | X | BA0 | BA1 | BG0 | BG1 |
| MRR | R1 | H | H | L | L | V |
| | F1 | X | L | H | H | SC |
| | R2 | H | MA4 | MA5 | MA6 | MA7 |
| | F2 | X | MA0 | MA1 | MA2 | MA3 |
| MPC | R1 | H | H | L | L | V |
| | F1 | X | H | L | H | V |
| | R2 | H | OP4 | OP5 | OP6 | OP7 |
| | F2 | X | OP0 | OP1 | OP2 | OP3 |
| MRW-1 | R1 | H | H | L | L | V |
| | F1 | X | L | L | H | BC |
| | R2 | H | MA4 | MA5 | MA6 | MA7 |
| | F2 | X | MA0 | MA1 | MA2 | MA3 |
| MRW-2 | R1 | H | H | L | L | V |
| | F1 | X | H | H | L | V |
| | R2 | H | OP4 | OP5 | OP6 | OP7 |
| | F2 | X | OP0 | OP1 | OP2 | OP3 |
| PRE | R1 | H | L | L | L | V |
| | F1 | X | H | H | V | SC |
| | R2 | H | V | V | V | AB |
| | F2 | X | BA0 | BA1 | BG0 | BG1 |
| REF | R1 | H | L | L | L | V |
| | F1 | X | H | L | RFM | SC |
| | R2 | H | dBG0 | dBG1 | V | AB |
| | F2 | X | BA0 | BA1 | BG0 | BG1 |
| WFF | R1 | H | H | L | L | V |
| | F1 | X | L | H | L | V |
| | R2 | H | V | V | V | V |
| | F2 | X | V | V | V | V |
| RFF | R1 | H | H | L | L | V |
| | F1 | X | H | L | L | V |
| | R2 | H | V | V | V | V |
| | F2 | X | V | V | V | V |
| RDC | R1 | H | H | L | L | V |
| | F1 | X | L | L | L | V |
| | R2 | H | V | V | V | V |
| | F2 | X | V | V | V | V |

In Table 1, cells with a “V” can indicate valid logic high level or low level is acceptable. BG0 and BG1 specify the bank group in a given sub-channel, while BA0 and BA1 specify the bank within a bank group. In static efficiency mode, SC specifies the sub-channel. When not in static efficiency mode, SC bits are don't cares. R0 to R16 can specify a page (row) address in a given bank. C0 to C5 specify a column address for a 32-byte data segment, while BL0 and BL1 specify an on-the-fly burst length as defined below in Table 2. The RFM bit in the refresh command indicate a normal refresh when low and a row hammer special refresh when high. Note that critical word first ordering can be supported on a 64-byte granularity. In other words, a critical 64 bytes can be provided first in a burst of 128 bytes. In addition, all other bursts can start at a column address zero of a data chunk.

TABLE 2
Burst Length and Column Addressing

| BL1 | BL0 | Burst Length | Lowest meaningful column address bit |
|---|---|---|---|
| 0 | 0 | BL8 (32B) | C0 |
| 0 | 1 | BL16 (64B) | C1 |
| 1 | 0 | BL32 (128B) | C2 (Use C1 for critical 64B) |

To restate some of the functions listed in Table 1, the deselect command and the NOP command results in the DRAM taking no action. The power-down entry (PED) command puts a sub-channel in a low-power state. For such a command, a DRAM takes various actions to save power, including, but not limited to, powering down CA receivers. Note that when sub-channels of a given channel are in power-down state, the DRAM's CK receiver and CK clock tree can also be powered down and a host can remove VDDQ power when all sub-channels on a given VDDQ rail are in power-down state. Note that VDDQ is a power pin in DDR memory that supplies power to output transistors of a device and can be known as a drain-to-drain core voltage. VDDQ provides energy and potential to drive a load applied to data output (Q) pins or data input/output (DQ) pins. The power-down state can be exited by asserting a CS high for a period of time. The self-refresh entry (SRE) command puts a DRAM sub-channel in self-refresh., similar to the LPDDR5 SRE command. The self-refresh exit (SRX) command takes a DRAM out of a self-refresh mode. If the write AL (additive latency) command sets a mode register to a non-zero value, the DRAM waits a number of clock cycles equal to the write-AL value after receiving a write command prior to executing it. Similarly, if a read AL (additive latency) command sets a mode register to a non-zero value, the DRAM waits a number of clock cycles equal to the Read-AL value after receiving a read command before executing it. The mode register read (MRR) command can read data from mode registers and return that data on DQ. Note that unlike LPDDR4, the LPW MRR command can also issue a refresh command in parallel with the write command. Refresh may be specified either per 2 banks or 4 banks, based on the mode register setting. Such a scheme can conserve command bandwidth when issuing refreshes. The mode register write (MRW) command writes data from the command/address (CA) bus to mode registers. The multi-purpose command (MPC) command can perform special functions, including those related to RDQS interval oscillators.

The activate (ACT) command can activate a row within a memory bank by moving a charge from capacitors into sense amplifiers. An activate command is used before accessing a column in DRAM by fetching data of a specific row of a DRAM array into a row buffer. A read command and/or a write command can then be issued to access the data in the row buffer. To then access data in a different row in the same bank, a precharge command is issued. This command closes the specific row by writing data from the row buffer back to memory. After some specified precharge period, the bank is ready to receive a new activate command.

For example, FIG. 7A illustrates an example of a timing diagram for activate commands, according to some embodiments. As shown, two activate commands to different memory bank groups (e.g., BG-A and BG-B) must be separated by at least tRRD_S. Further, the tTAW parameter specifies a maximum of two activate commands within a designated window, referred to as a two-activate timing window. The memory controller will prevent generation of a third activate command after two consecutive activate commands within a tTAW window. The third activate command will not be sent until the two-activate timing window has passed.

One particular use case that the LPW standard has attempted to optimize for is when interleaved memory accesses (either reads or writes) to previously closed pages in different bank groups are to occur. The parameter tRRD_S specifics a minimum time period between accesses to different bank groups. The specification of tTAW allows two activate commands to be scheduled close enough together in time to start interleaved read or write operations to previously closed pages in different bank groups, without adding more delay between the associated activate commands. In one implementation, ITAW is 10 ns for memory access speeds of 3.2 Gbps and 1.6 Gbps and 20 ns for a memory access speed of 0.8 Gbps. As has been noted, any two activate commands to the same memory bank group must be separated by at least tRRD_L. Adoption of the two-activate timing window allows power distribution circuit 710 depicted in FIG. 7B to better manage the power budget of DRAM device 300. Power distribution circuit 710 thus need not be designed to support three or more activate commands in close succession. The two-activate timing window is thus in accord with LPW's low-power philosophy.

As shown in FIG. 7C, memory interface circuit 720, that portion of memory controller circuit 245 that interfaces with memory 120, is configured to generate, among other things, activate commands 726 to DRAM device 300. As has been discussed, these activate command are subject to various timing specifications 725, which memory interface circuit 720 is configured to enforce.

FIG. 7D is a block diagram of one embodiment of a memory interface circuit that enforce the tTAW timing specification. Memory interface circuit 720, based on receiving memory access requests 727, is configured to generate activate command 726 when certain conditions are satisfied. As depicted, memory interface circuit 720 includes activation initiation circuit 728, activation generation circuit 732, activation counter 736, and two-activate timer circuit 738.

Activation initiation circuit 728, in one embodiment, may receive a memory access request 727 for which an activate will be needed. A particular activate signal 729 may be selected from multiple possible activate candidates, and passed on to activation generation circuit 732 via buffer 730 if the tTAW timing specification is met.

When activation generation circuit 732 outputs an activate command 726 to DRAM device 300, an indication of this activate command is sent to activation counter 736. If counter 736 is not currently active, receipt of an activate command 726 sets activation counter 736 to one. Activation counter 736 cause two-activate timer 738 to begin. Two-activate timer 738, once it begins running, is active for a time period equal to tTAW. When two-activate timer 738 indicates that the tTAW time period has elapsed, it will cause activation counter 736 to be reset, thus beginning a new two-activate timing window.

While two-activate timer 738 is active, any activate command 726 that is generated will cause activation counter 736 to be incremented. While the value of activation counter is less than 2, signal 731 and two-activate timer 738 is active, activate-permitted signal 731 will be true, which will cause buffer 730 to pass on particular activate signal 729. But when activation counter 736 reaches a value of two and two-active timer 738 is active, this means that DRAM device 300 has reached its maximum number of activates during the current two-activate timing window. Note that when two-activate timer 738 elapses, this will reset activation counter 736, such that subsequent activates will be permitted.

FIG. 7E is a flow diagram of one embodiment of a method for implementing a two-activate timing window for DRAM. Method 740 is written from the perspective of a memory interface circuit within a memory controller circuit 245. Method 740 begins at 744, in which the memory interface circuit generates a first activate command to a first row in a first bank group of a dual data rate (DDR) dynamic random-access memory (DRAM) device. In 748, the memory interface circuit, based on generation of the first activate command, begins a current two-activate timing window having a first time period. In 752, the memory interface circuit, during the current two-activate timing window, prevents generation of more than one additional activate command. Finally, in 756, the memory interface circuit, based on expiration of the current two-activate timing window, begins a new current two-activate timing window.

This timing specification thus permits the beginning of interleaved memory access commands to different bank groups of the DRAM device. Preventing generation of no more than one additional activate command during the current two-activate timing window may include starting a timer based on generation of the first activate command to begin a current two-activate timing window. During the current two-activate timing window, the memory interface circuit may track additional activate commands that are generated and sent to the DRAM device. After one additional activate command has been generated during the current two-activate timing window, the method may include the memory interface circuit blocking any further activates for a remainder of the two-activate timing window. Upon the timer indicating that the current two-activate timing window has expired, the method may further include resetting the timer to begin a new current two-activate timing window in which an activate can now be generated.

The first time period may vary based on a clock speed of the DRAM device. For example, the first time period may be twice the length of a second time period (tRRD_S) that specifies a minimum time between activates generated for two different bank groups. For a transfer rate of the DRAM device of 800 mega transfers per second (MT/s), the first time period may be 20 ns. For a transfer rate of the DRAM device of 3200 mega transfers per second (MT/s), the first time period may be 10 ns.

FIG. 7F is a flow diagram of one embodiment of a method for implementing a two-activate timing window for DRAM. Method 760 is written from the perspective of a DDR DRAM device having DRAM cells organized into bank groups. Method 760 begins in 764, in which the DDR DRAM device receives, from a memory interface circuit of a computer system, a first activate command to a first row in a first bank group of DRAM cells. In 768, a power distribution circuit of the DRAM device recharges, within a first time period (tRRD_S), the DRAM cells. Next, in 772, the DRAM device receives, from the memory interface circuit after the first time period has elapsed, a second activate command to a second row in a second bank group of DRAM cells. In 776, the power distribution circuit recharges, within a second time period (tTAW) beginning from the first activate command, the DRAM cells, where the second time period is greater than the first time period. Finally, in 780, the DRAM device receives, from the memory interface circuit after the second time period has elapsed, a third activate command to a third row of DRAM cells. (The third activate signal is a next activate command after the second activate command.)

A number of variations of method 760 are contemplated. For example, the first and second activate commands may correspond to a beginning of interleaved memory access commands to different bank groups of the DRAM device. Additionally, the first time period and the second time period may vary based on a clock speed of the DRAM device, with the second time period varying between two times to four times the first time period.

The length of the second time period may vary for different DRAM transfer rates. For example, at transfer rates of 800 mega transfers per second (MT/s) and 1600 MT/s, the second time period is twice the first time period. Conversely, at a transfer rate of 3200 mega transfers per second (MT/s), the second time period is four times the first time period. In one embodiment, at 800 MT/s, the first time period is 10 ns and the second time period is 20 ns; at 1600 MT/s, the first time period is 5 ns and the second time period is 10 ns; and 3200 MT/s, the first time period is 2.5 ns and the second time period is 10 ns.

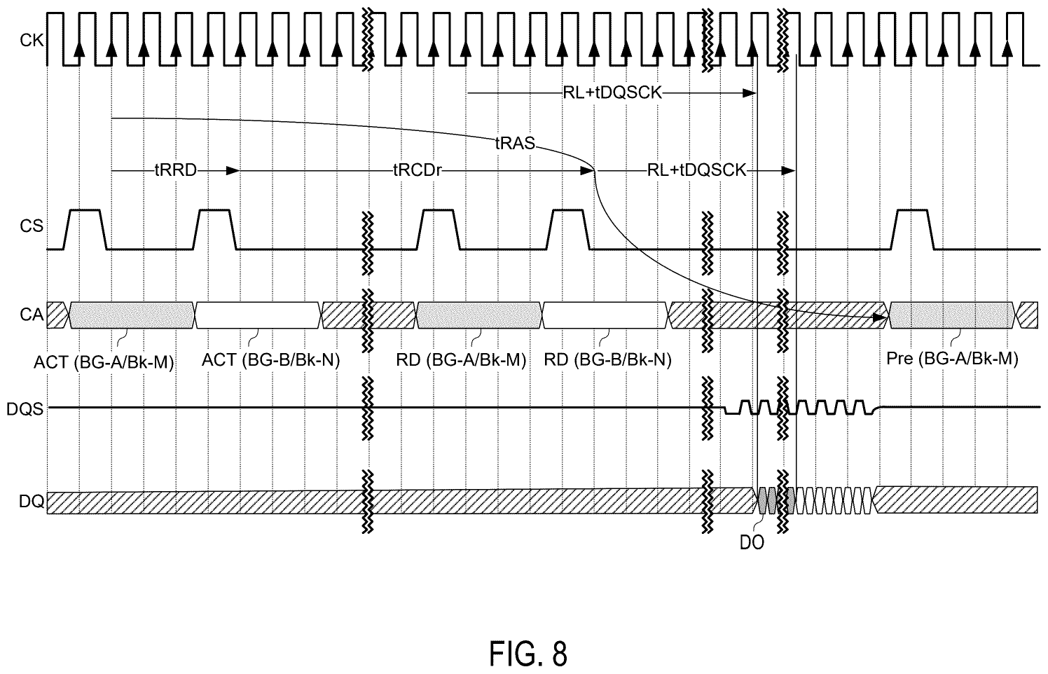

FIG. 8 illustrates an example of a timing diagram for a sequence of activate, read, and precharge commands. As shown, two activate commands to different memory bank groups (e.g., BG-A/Bk-M) and (BF-B/Bk-N) are separated by at least tRRD_S. In addition, a minimum delay between an activate command and a read command for a memory bank group can be defined as tRCDr, where tRCDr is 17.5 ns for a memory access speed of 3.2 Gbps and 18 ns for memory access speeds for 1.6 Gbps and 0.8 Gbps. Further, a delay between a read command and a read data burst start can be set as a sum of a minimum number of command clock periods (tCKs), e.g., RL, and a delay to start reading data queues (RDQs), e.g., IRDQSCK. RL can be defined as 32 tCKs for a memory access speed of 3.2 Gbps, 16 tCKs for a memory access speed of 1.6 Gbps, and 8 tCKs for a memory access speed of 0.8 Gbps. IRDQSCK can be defined as a range between a minimum value (e.g., tRDQSCK_min) and a maximum value (e.g., tRDQSCK_max). For example, tRDQSCK can be defined to have a minimum value of 1 ns and a maximum value of 3.1 ns. In addition, a row activation time, (RAS, e.g., a time from row activation to row precharge (e.g., PRE (BG-A/Bk-M) can be defined (e.g., as 42 ns).

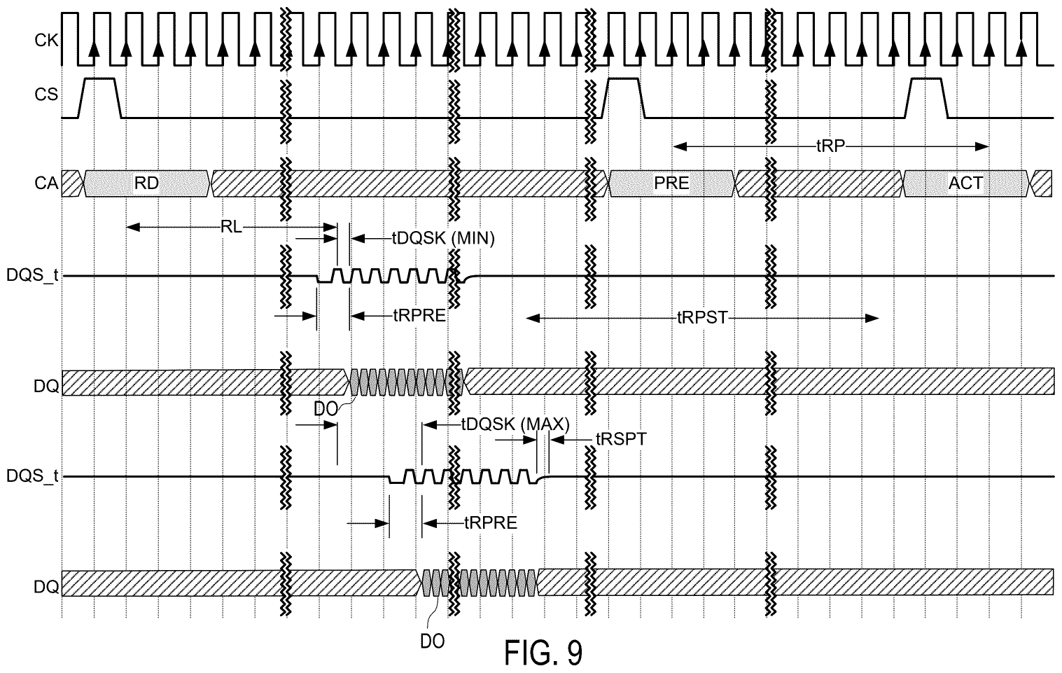

FIG. 9 illustrates an example of a timing diagram for a burst read timing with precharge and activate commands, according to some embodiments. Note that RD (i.e., “read”) commands can read a burst from a given column address of a currently open page in a bank addressed. A burst length of 8, 16, or 32 can be specified on the fly for each read command. Note that when operating at a memory access speed of 3.2 Gbps, burst lengths of 16 (BL16) or 32 (BL32) can be provided in interleaved groupings of burst length 8 (BL8). Note further, that in some embodiments, when operating at 1.6 Gbps or below, LPW can operate only in non-BG mode. In some instances, unlike LPDDR5, an LPW read command can issue a refresh command in parallel with a read command. For example, when a reference (REF) bit of the read command is set (e.g., set to a value of 1), two memory banks can be refreshed, e.g., specified by {0, rBA2, rBA1, rBA0} and {1, rBA2, rBA1, rBA0}, where rBA0, rBA1, and rBA2 are fields in the read command specifically for this purpose. (The memory bank being read from cannot be a target of the refresh in that command.) Such a scheme can conserve command bandwidth when issuing refreshes. As noted, a read AL command can be used to insert a delay from receiving a read command until beginning execution of it. As shown in FIG. 9, a maximum read time for a data strobe (RDQS) post-amble, tRPST, can be defined as 1.5 tCKs. In addition, as shown, a minimum row precharge time, tRP, can be defined as 17.5 ns.

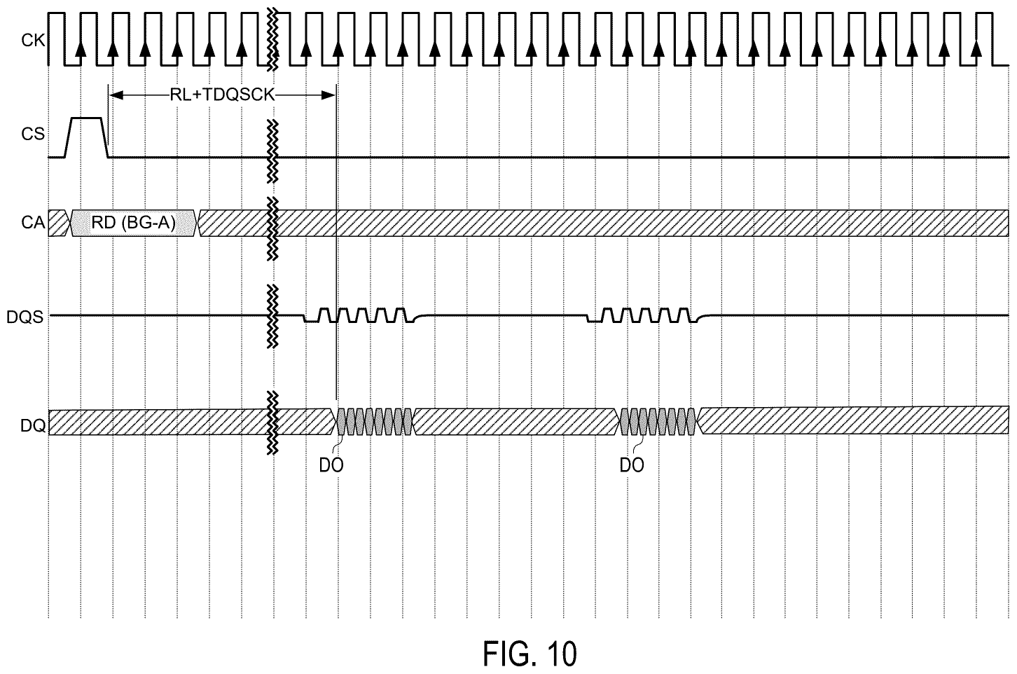

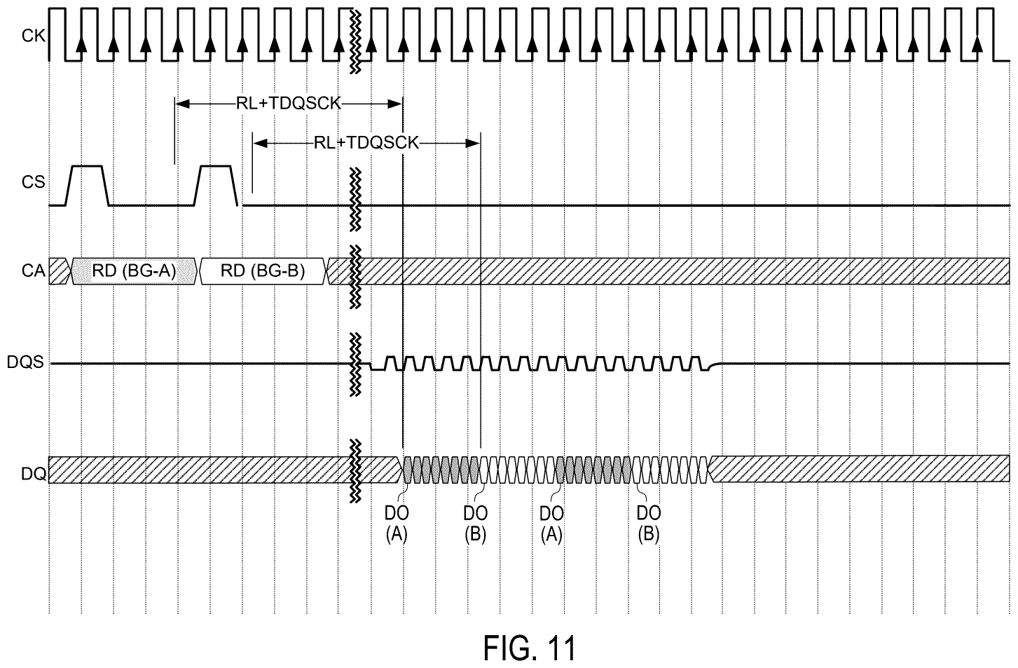

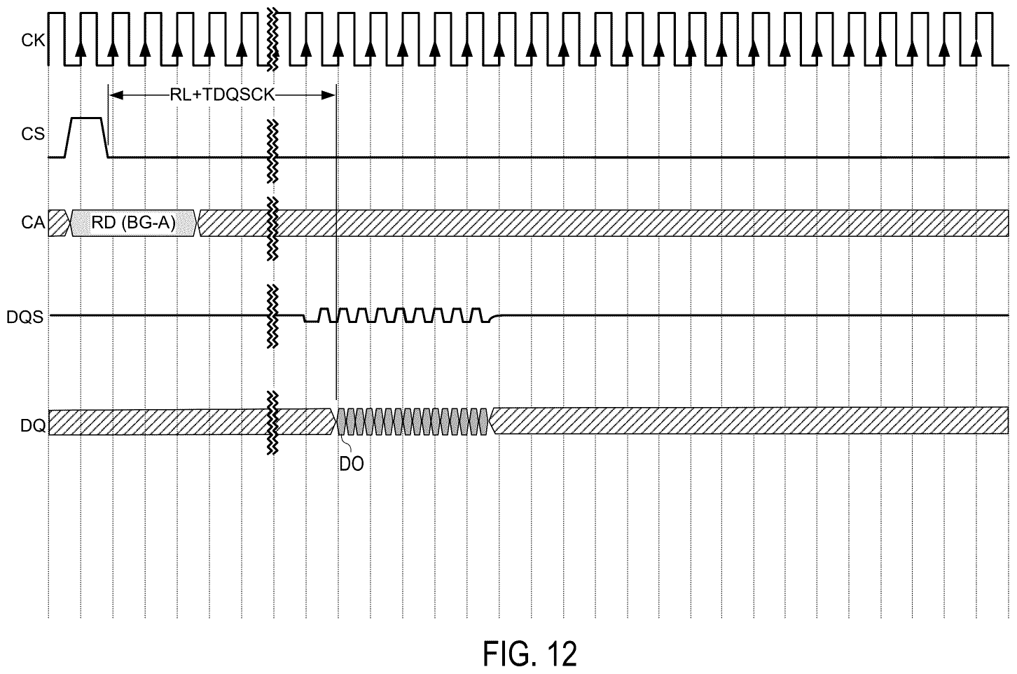

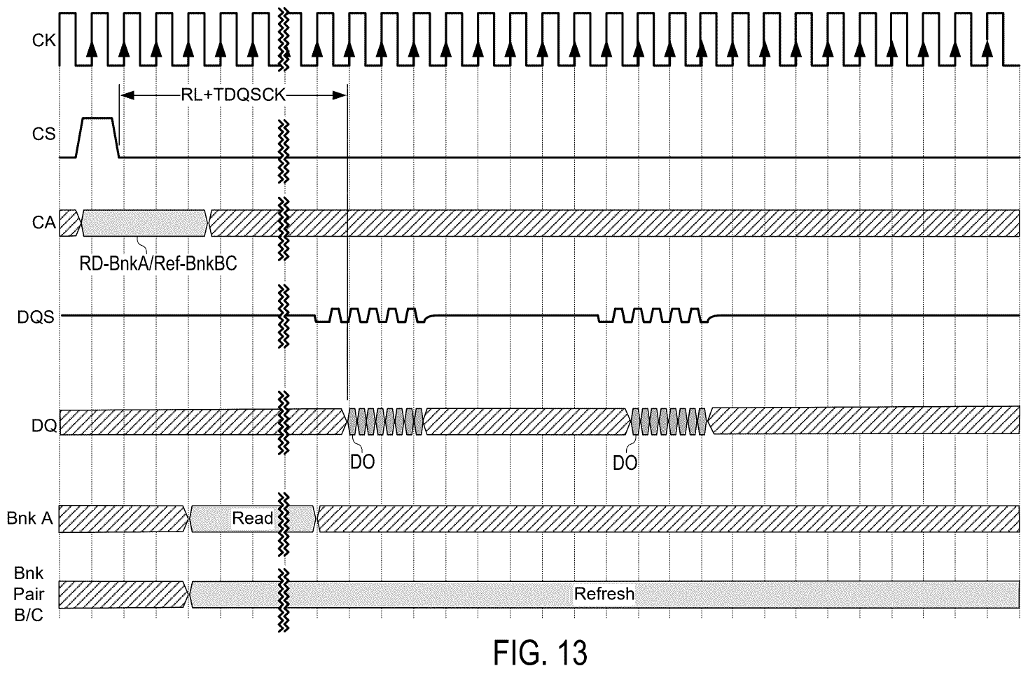

FIGS. 10, 11, 12, and 13 illustrate timing diagrams for various read modes, according to some embodiments. For example, FIG. 10 illustrates an example of a timing diagram for a bank group (BG) mode BL 16 read and FIG. 11 illustrates an example of a timing diagram for a BG mode interleaved BL 16 read. FIG. 12 illustrates an example of a timing diagram for a non-BG mode BL 16 read and FIG. 13 illustrates an example of a timing diagram for a BL 8 read with a refresh command.

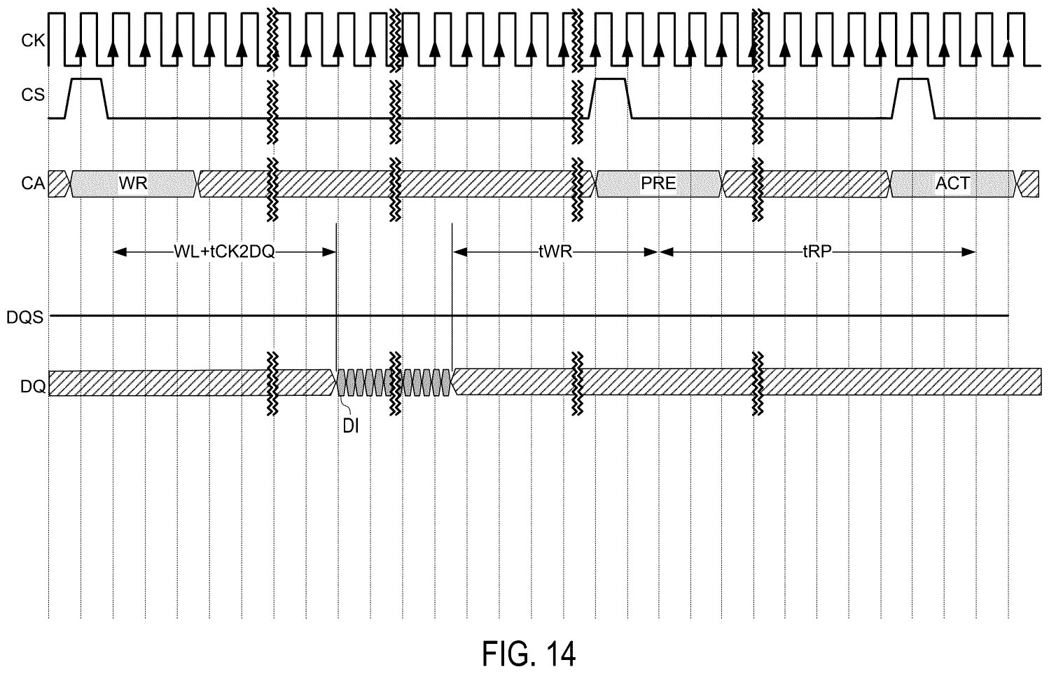

FIG. 14 illustrates an example of a timing diagram for burst write timing, according to some embodiments. Note that the WR (“write”) commands can write a burst to a given column address of a currently open page in a bank addressed. A burst length of 8, 16, or 32 can be specified on-the-fly for each write command. Note that when operating at a memory access speed of 3.2 Gbps, burst lengths of 16 or 32 can be provided in interleaved groupings of BL8. Note further, that when operating at a memory access speed of 1.6 Gbps or below, LPW can only operate in non-BG mode. In some instances, unlike LPDDR5, an LPW write command can also issue a refresh command in parallel with the write command. For example, when a reference (REF) bit of the write command is set (e.g., set to a value of 1), two memory banks can be refreshed, specified by fields in the write command designed specifically for this purpose. (Note that the bank being written to cannot be a target of the refresh in the write command.) Such a scheme can conserve command bandwidth when issuing refreshes. As noted, a write AL command can be used to cause a delay after receiving a write command until beginning execution of it. Additionally, as shown in FIG. 14, a delay between a write command to a write data burst start can be set as a sum of a minimum number of command clock periods (tCKs), e.g., WL, and a delay to start writing data queues, e.g., tCK2DQ. WL can be expressed in terms of tCKs and as a function of memory access speed. The parameter tCK2DQ can be defined as a range between a minimum value (e.g., tCK2DQ_min) and a maximum value (e.g., tCK2DQ_max). Further, a minimum write recovery time (tWR), e.g., prior to a precharge command can be defined (e.g., as 34 ns). In addition, as shown, a minimum row precharge time, tRP, can be defined as 17.5 ns.

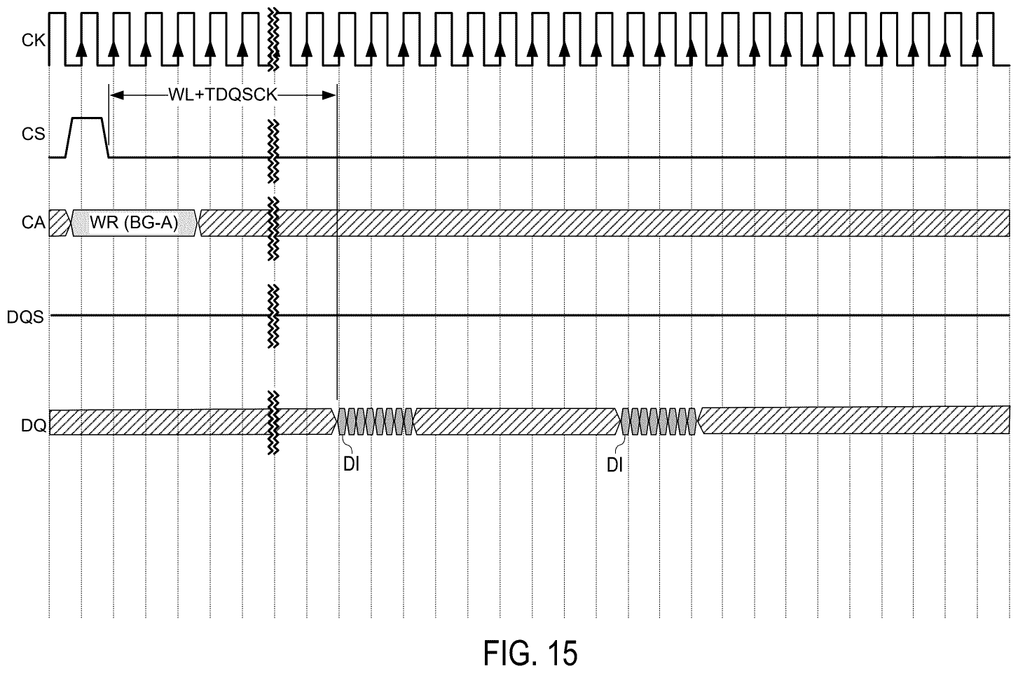

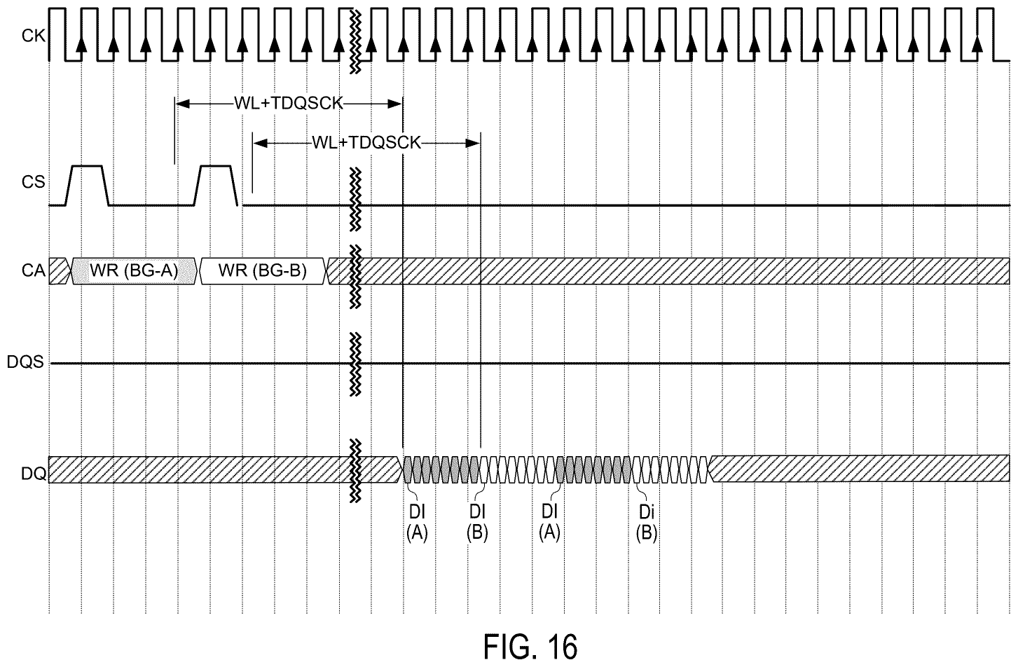

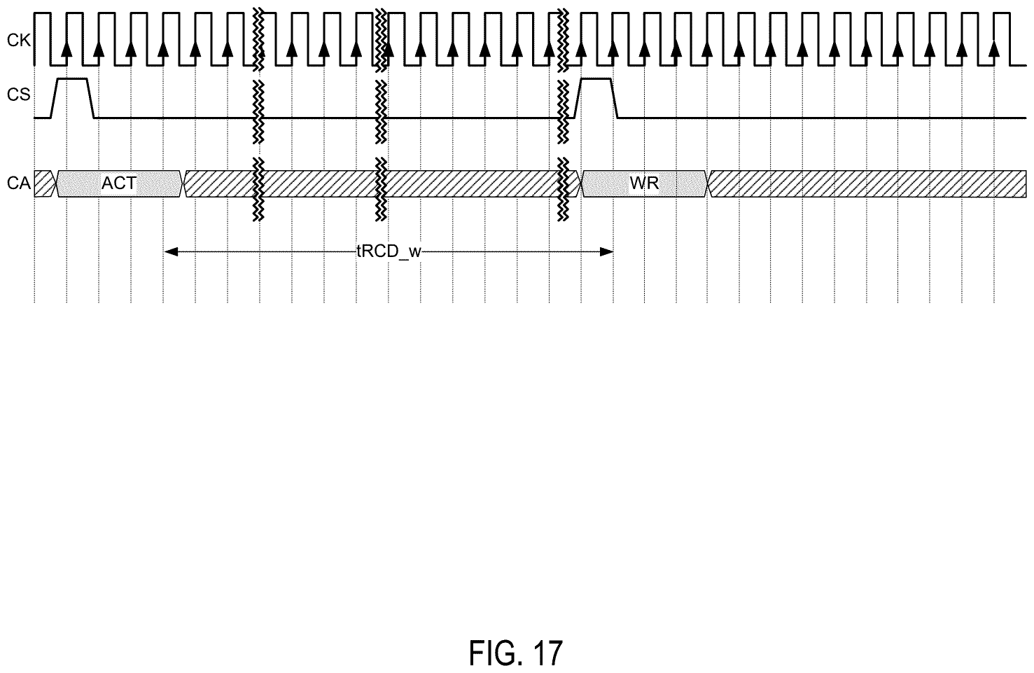

FIGS. 15, 16, and 17 illustrate example timing diagrams for various write modes, according to some embodiments. For example, FIG. 15 illustrates an example of a timing diagram for a BG mode BL 16 write. As another example, FIG. 16 illustrates an example of a timing diagram for a BG mode interleaved BL 16 write. As a further example, FIG. 17 illustrates an example of a timing diagram for an activate command followed by a write command, according to some embodiments. As shown, a minimum delay between an activate command and a write command, e.g., tRCDw, can be defined. For example, tRCDw can be defined as 7.5 ns.

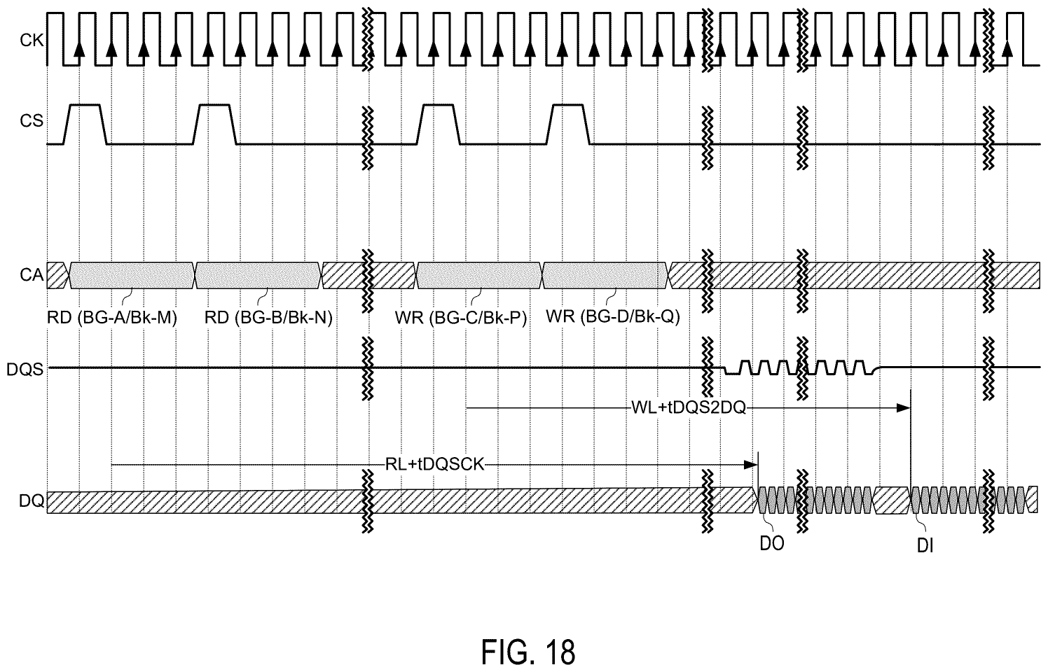

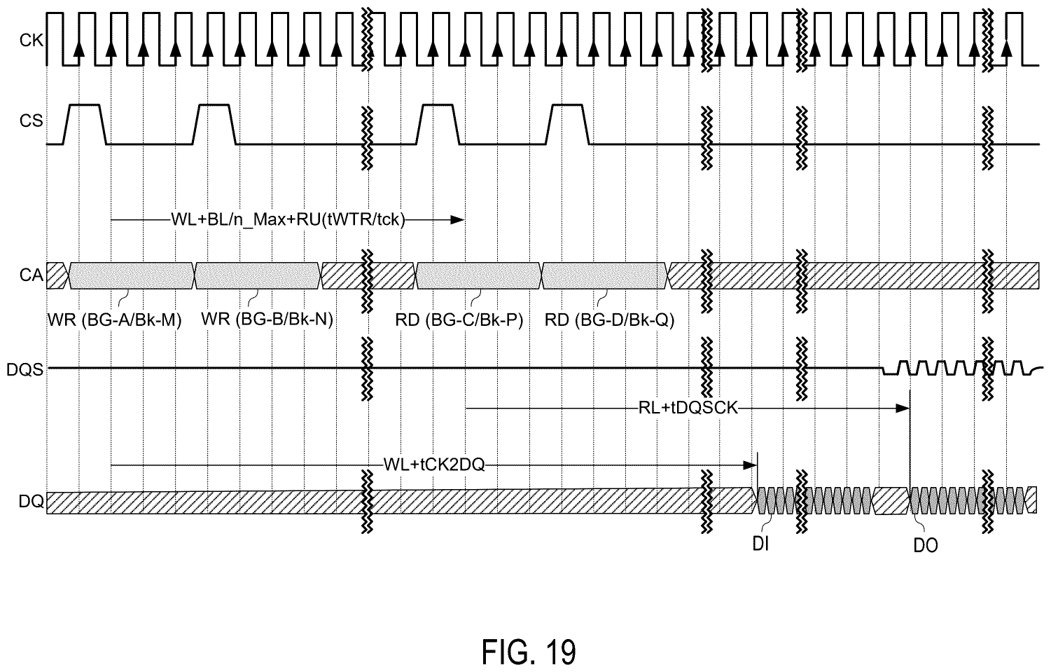

FIGS. 18 and 19 illustrate examples of timing diagrams for read command/write command interaction, according to some embodiments. For example, FIG. 18 illustrates a timing diagram for a read command followed by a write command and FIG. 19 illustrates an example of a timing diagram for a write command followed by a read command. Note that the only timing requirement from a read command to a write command or a write command to a read command is ensuring no contention on a data pin (DQ).

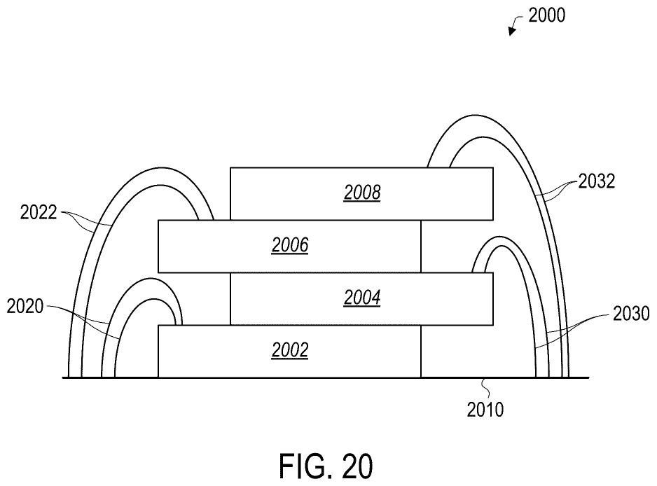

FIG. 20 illustrates an example of a memory die stack, according to some embodiments. In at least some instances, the memory die stack 2000 can be considered a memory channel. Further, in some instances, the memory die stack 2000 can be configured to operate according to the timing parameters and relationships described herein. Additionally, memory die stack 2000 can be in communication with one or more processors, e.g., processor circuits 240A-B. As shown, the memory die stack 2000 can include memory dies 2002, 2004, 2006, and 2008. The memory die stack 2000 can be positioned on a printed circuit board 2010. Die 2002 (e.g., a first die) can be positioned on the PCB 2010 and a die 2004 (e.g., a second die) can be positioned adjacent to (e.g., on top of or stacked on) the die 2002 and slightly offset to one side as compared to the die 2002. Die 2006 (e.g., a third die) can be positioned adjacent to (e.g., on top of or stacked on) die 2006 die and slightly offset to one side as compared to the second die. The offset can be in an opposite direction as the offset between die 2002 and die 2004. Thus, die 2006 can be considered as aligned or substantially aligned with die 2002. Die 2006 (e.g., a fourth die) can be positioned adjacent to (e.g., on top of or stacked on) die 2006 and slightly offset to one side as compared to die 2006. The offset can in an opposite direction as the offset between die 2004 and die 2006. Thus, die 2008 can be considered as aligned or substantially aligned with die 2004. Further, as shown, wiring 2020 from die 2002 to the PCB 2010 and wiring 2022 from die 2006 to the PCB 2010 can be located on a same side of die 2002 and die 2006. Similarly, wiring 2030 from die 2004 to the PCB 2022 and wiring 2032 from die 2008 to the PCB 2010 can be located on a same side of die 2004 and die 2008, where the wiring 2030 and 2032 is on the opposite side of the die stack 2000 as compared to the wiring 2020 and 2022. Such a scheme can lead to reduced crosstalk between die 2002 and die 2004, and similarly, between die 2006 and die 2008. Note that multiple die stacks 2000 can be placed on PCB 2010 to form a memory package, at least in some instances.

### Example Applications

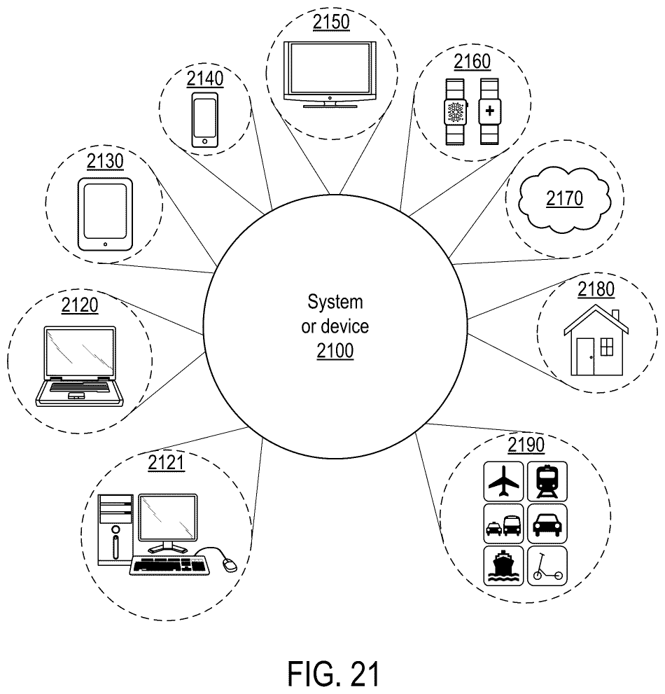

Turning now to FIG. 21, various types of applications or platforms that may include any of the circuits, devices, or systems discussed above are illustrated. System or device 2210, which may incorporate or otherwise utilize one or more of the techniques described herein, may be utilized in a wide range of areas. For example, system or device 2100 may be utilized as part of the hardware of systems such as a desktop computer 2121, laptop computer 2120, tablet computer 2130, cellular or mobile phone 2140, or television 2150 (or set-top box coupled to a television).

Similarly, disclosed elements may be utilized in a wearable device 2160, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 2100 may also be used in various other contexts. For example, system or device 2100 may be utilized in the context of a server computer system, such as a dedicated server or on shared hardware that implements a cloud-based service 2170. Still further, system or device 2100 may be implemented in a wide range of specialized everyday devices, including devices 2180 commonly found in the home such as refrigerators, thermostats, security cameras, etc. The interconnection of such devices is often referred to as the “Internet of Things” (IoT). Elements may also be implemented in various modes of transportation. For example, system or device 2100 could be employed in the control systems, guidance systems, entertainment systems, etc. of various types of vehicles 2190.

The applications illustrated in FIG. 21 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

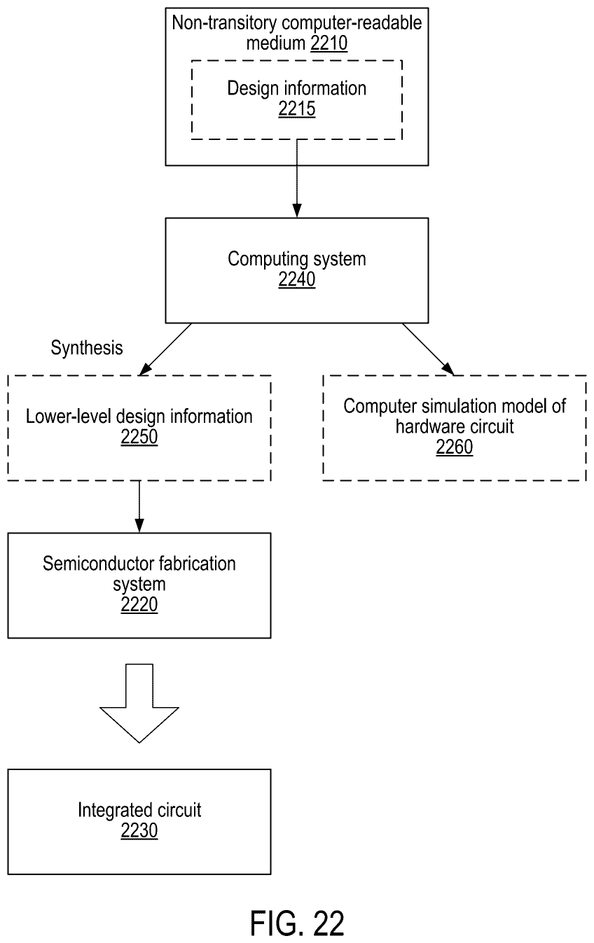

FIG. 22 is a block diagram illustrating an example non-transitory computer-readable storage medium that stores circuit design information, according to some embodiments. In the illustrated embodiment, computing system 2240 is configured to process the design information. This may include executing instructions included in the design information, interpreting instructions included in the design information, compiling, transforming, or otherwise updating the design information, etc. Therefore, the design information controls computing system 2240 (e.g., by programming computing system 2240) to perform various operations discussed below, in some embodiments.

In the illustrated example, computing system 2240 processes the design information to generate both a computer simulation model 2260 of a hardware circuit and lower-level design information 2250. In other embodiments, computing system 2240 may generate only one of these outputs, may generate other outputs based on the design information, or both. Regarding the computing simulation, computing system 2240 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 2240 also processes the design information to generate lower-level design information 2250 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 2250 (potentially among other inputs), semiconductor fabrication system 2220 is configured to fabricate an integrated circuit 2230 (which may correspond to functionality of the simulation model 2260). Note that computing system 2240 may generate different simulation models based on design information at various levels of description, including information 2250, 2215, and so on. The data representing design information 2250 and model 2260 may be stored on medium 2210 or on one or more other media.

In some embodiments, the lower-level design information 2250 controls (e.g., programs) the semiconductor fabrication system 2220 to fabricate the integrated circuit 2230. Thus, when processed by the fabrication system, the design information may program the fabrication system to fabricate a circuit that includes various circuitry disclosed herein.

Non-transitory computer-readable storage medium 2210, may comprise any of various appropriate types of memory devices or storage devices. Non-transitory computer-readable storage medium 2210 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 2210 may include other types of non-transitory memory as well or combinations thereof. Accordingly, non-transitory computer-readable storage medium 2210 may include two or more memory media; such media may reside in different locations—for example, in different computer systems that are connected over a network.

Design information 2215 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 2240, semiconductor fabrication system 2220, or both. In some embodiments, design information may also include one or more cell libraries that specify the synthesis, layout, or both of integrated circuit 2230. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 2230 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 2220 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 2220 may also be configured to perform various testing of fabricated circuits for correct operation.

In various embodiments, integrated circuit 2230 and model 2260 are configured to operate according to a circuit design specified by design information 2215, which may include performing any of the functionality described herein. For example, integrated circuit 2230 may include any of various hardware elements shown throughout this disclosure. Further, integrated circuit 2230 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 2220 to fabricate integrated circuit 2230.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom-designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifics a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
a dynamic random-access memory (DRAM) device that includes:
a set of DRAM cells;
an external interface, the external interface having a first pair of pins for a clock interface, four pins for a first command and address bus, and thirty two pins for a first data bus;
the first command and address bus, wherein the first command and address bus is configured to convey memory commands and addresses to the set of DRAM cells;
the first data bus, wherein the first data bus is configured to convey memory access data to and from the set of DRAM cells; and
a first clock distribution circuit coupled to the first pair of pins; and
wherein the DRAM device is configured to:
receive, from a memory interface circuit at the first pair of pins, a first differential clock signal;
drive, by the first clock distribution circuit based on the first differential clock signal, an indication of validity of:
information on the first command and address bus; and
thirty two bits of write data being conveyed to the DRAM device via the first data bus.

2. The apparatus of claim 1, wherein the external interface of the DRAM device has a different pair of pins, and wherein the DRAM device is configured to:
receive, from the memory interface circuit at the different pair of pins, a differential read strobe signal; and
indicate, based on the differential read strobe signal, validity of read data on the first data bus that has been accessed from the set of DRAM cells.

3. The apparatus of claim 1, wherein the set of DRAM cells includes a plurality of portions, including:
a first portion of DRAM cells coupled to the first command and address bus and the first data bus, and corresponding to a first sub-channel; and
a second portion of DRAM cells coupled to a second command and address bus and a second data bus, and corresponding to a second sub-channel.

4. The apparatus of claim 3, wherein the plurality of portions includes, in addition to the first portion and the second portion, one or more additional portions, wherein each of the plurality of portions has a thirty-two-bit data bus interface to the set of DRAM cells.

5. The apparatus of claim 1, wherein the DRAM device is configured to support a transfer rate of 3200 mega transfers per second (MT/s) on the first data bus.

6. The apparatus of claim 1, wherein the DRAM device is configured to support a transfer rate of at least 800 mega transfers per second (MT/s) on the first data bus.

7. The apparatus of claim 1, wherein the DRAM device includes a frequency set point register that specifies operation of the DRAM device at a particular frequency of multiple possible frequencies, wherein the DRAM device further includes a set of mode registers, each configured to store mode values for each of the multiple possible frequencies, and wherein the DRAM device is configured, in response to receiving a change in a value of the frequency set point register, to begin, based on the change, using different mode values stored int eh set of mode registers without a loss of communication on the first command and address bus and the first data bus.

8. A method, comprising:
receiving, at a dynamic random-access memory (DRAM) device from a memory interface circuit, a first differential clock signal at a first pair of pins of an external interface of the DRAM device, the DRAM device including a set of DRAM cells, a first command and address bus that is 4 bits wide, and a first data bus that is thirty-two bits wide;
indicating, by the DRAM device based on the first differential clock signal, validity of information on the first command and address bus; and
indicating, by the DRAM device based on the first differential clock signal, validity of write data for an entirety of the first data bus, the first differential clock signal being distributed within the DRAM device via a first clock distribution circuit coupled to the first pair of pins.

9. The method of claim 8, further comprising:
receiving, at the DRAM device from the memory interface circuit, a differential read strobe signal at a different pair of pins of the external interface of the DRAM device; and
indicating, by the DRAM device based on the differential read strobe signal, validity of read data on the first data bus that has been accessed from the set of DRAM cells.

10. The method of claim 8, wherein the set of DRAM cells includes a plurality of portions, including a first portion of DRAM cells addressable via a first sub-channel that includes the first command and address bus and the first data bus, and a second portion of DRAM cells addressable via a second sub-channel that includes a second command and address bus and a second data bus.

11. The method of claim 10, wherein the plurality of portions includes, in addition to the first portion and the second portion, one or more additional portions, wherein each of the plurality of portions has a thirty-two-bit data bus interface to the set of DRAM cells.

12. The method of claim 10, further comprising:
receiving, at the DRAM device from the memory interface circuit, a second differential clock signal at a second pair of pins of the external interface of the DRAM device;
indicating, based on the second differential clock signal, validity of information on the second command and address bus; and
indicating, based on the second differential clock signal, validity of data on an entirety of the second data bus, the second differential clock signal being distributed within the DRAM device via a second clock distribution circuit coupled to the second pair of pins.

13. The method of claim 8, wherein the first data bus is operating at a transfer rate of over 3000 mega transfers per second (MT/s).

14. An apparatus, comprising:
a computer system formed on one or more co-packaged integrated circuits, the computer system including:
a network circuit;
a plurality of agent circuits configured to communicate via the network circuit, the plurality of agent circuits including a plurality of processor circuits and a memory controller circuit that includes a memory interface circuit;
a dynamic random-access memory (DRAM) device coupled to the computer system via the memory interface circuit, wherein the DRAM device includes:
a set of DRAM cells, including a first portion of DRAM cells;
an external interface that includes a first pair of pins for a clock interface, four pins for a first command and address bus coupled to the first portion of DRAM cells, and thirty two pins for a first data bus coupled to the first portion of DRAM cells;
the first command and address bus;
the first data bus;
a first clock distribution circuit coupled to the first pair of pins; and
wherein the DRAM device is configured to:
receive, from the memory interface circuit at the first pair of pins, a first differential clock signal;
drive, by the first clock distribution circuit based on the first differential clock signal, an indication of validity of:
information on the first command and address bus; and
thirty-two bits of write data being conveyed to the DRAM device via the first data bus.

15. The apparatus of claim 14, wherein the external interface of the DRAM device has a second pair of pins, and wherein the DRAM device is configured to:
receive, from the memory interface circuit at the second pair of pins, a differential read strobe signal; and
indicate, based on the differential read strobe signal, validity of read data on the first data bus that has been accessed from the set of DRAM cells.

16. The apparatus of claim 14, wherein the external interface includes a second pair of pins, four pins for a second command and address bus coupled to a second portion of DRAM cells, and thirty two pins for a second data bus coupled to the first portion of DRAM cells, wherein the DRAM device further includes:
a second clock distribution circuit coupled to the second pair of pins; and
wherein the DRAM device is configured to:
receive, from the memory interface circuit at the second pair of pins, a second differential clock signal;
drive, by the second clock distribution circuit based on the second differential clock signal, an indication of validity of:
information on the second command and address bus; and
thirty-two bits of write data being conveyed to the DRAM device via the second data bus.

17. The apparatus of claim 14, wherein the external interface includes more than two sub-channels per DRAM device, each sub-channel having a thirty-two-bit data bus.

18. The apparatus of claim 14, wherein the DRAM device is configured to support a transfer rate of 3200 mega transfers per second (MT/s) on the first data bus.

19. The apparatus of claim 14, wherein the DRAM device is configured to support transfer rates over 800 mega transfers per second (MT/s) on the first data bus.

20. The apparatus of claim 14, wherein the DRAM device is co-packaged with one or more other DRAM devices.
